(19) United States
(12) Patent Application Publication
(10) Pub. No.: US 2016/0103714 A1
(43) Pub. Date: Apr. 14, 2016

(54) SYSTEM, METHOD OF CONTROLLING A SYSTEM INCLUDING A LOAD BALANCER AND A PLURALITY OF APPARATUSES, AND APPARATUS

(71) Applicant: FUJITSU LIMITED, Kawasaki-shi (JP)

(72) Inventors: Yotaro Konishi, Yokohama (JP); Takashi Miyoshi, Ohta (JP)

(73) Assignee: FUJITSU LIMITED, Kawasaki-shi (JP)

(21) Appl. No.: 14/870,309

(22) Filed: Sep. 30, 2015

(30) Foreign Application Priority Data
Oct. 10, 2014 (JP) 2014-209072

(51) Int. Cl. G06F 9/50

(52) U.S. Cl. CPC G06F 9/5083; G06F 9/5016; G06F 9/505

(57) ABSTRACT

A system includes a load balancer; apparatuses; a control apparatus configured to execute a process including: selecting, from among the apparatuses, one or more first apparatuses as each processing node for processing data distributed by the load balancer, selecting, from among the apparatuses, one or more second apparatuses as each inputting and outputting node for inputting and outputting data processed by the each processing node, collecting load information from the one or more first apparatuses and the one or more second apparatuses, changing a number of the one or more first apparatuses or a number of the one or more second apparatuses based on the load information, and setting one or more third apparatuses not selected as the processing node and the inputting and outputting node from among the apparatuses based on the changing into a deactivated state.

### CROSS-REFERENCE TO RELATED APPLICATION

This application is based upon and claims the benefit of priority of the prior Japanese Patent Application No. 2014-209072, filed on Oct. 10, 2014, the entire contents of which are incorporated herein by reference.

### FIELD

The embodiments discussed herein are related to a system, a method of controlling a system including a load balancer and a plurality of apparatuses, and an apparatus.

### BACKGROUND

A method has been proposed in which, in a computer system in which a given number of processors are coupled to a given number of storage apparatus, the number of processors or the number of storage apparatus included in the computer system is changed in response to a variation of the load. Further, a method has been proposed in which, in a storage apparatus, when the load such as a data amount to be inputted or outputted or the like increases, a storage apparatus is added so that the load is distributed.

As an example of a prior art document, Japanese National Publication of International Patent Application No. 2003-507817 and Japanese Laid-open Patent Publication No. 2006-53601 are known.

### SUMMARY

According to an aspect of the embodiments, a system includes a load balancer; a plurality of information processing apparatuses; a control apparatus including a memory and a processor coupled to the memory, wherein the processor is configured to execute a process including: selecting, from among the plurality of information processing apparatuses, one or more first information processing apparatuses as each processing node for processing data distributed by the load balancer, selecting, from among the plurality of information processing apparatuses, one or more second information processing apparatuses as each inputting and outputting node for inputting and outputting data processed by the each processing node, collecting load information from the one or more first information processing apparatuses and the one or more second information processing apparatuses, changing a number of the one or more first information processing apparatuses or a number of the one or more second information processing apparatuses based on the load information, data being distributed to the changed one or more first processing apparatuses based on the changing by the load balancer when the number of the one or more first information processing apparatuses is changed, and setting one or more third information processing apparatuses not selected as the processing node and the inputting and outputting node from among the plurality of information processing apparatuses based on the changing into a deactivated state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting an information processing system of an embodiment;

FIG. 2 is a block diagram depicting an example of a state when a load to an inputting and outputting node increases in the information processing system depicted in FIG. 1;

FIG. 3 is a block diagram depicting another embodiment of an information processing system, a controlling method for the information processing system, and a controlling program of a controlling apparatus;

FIG. 4 is a block diagram depicting an example of the controlling apparatus depicted in FIG. 3;

FIG. 5 is a block diagram depicting an example of a front end server, a storage server and a sleep server depicted in FIG. 3;

FIG. 6 is a view depicting an example of a server management table, a disk management table, a hash table and a retry table depicted in FIGS. 4 and 5;

FIG. 7 is a view depicting an example of a hash space indicated by the hash table depicted in FIG. 6;

FIG. 8 is a view depicting an example of a switching apparatus depicted in FIG. 3;

FIG. 9 is a view depicting an example of a state when a load to front end servers increases in the information processing system depicted in FIG. 3;

FIG. 10 is a view depicting an example of a server management table, a disk management table, a hash table and a retry table in the information processing system depicted in FIG. 9;

FIG. 11 is a block diagram depicting an example of a state when a load to storage servers increases in the information processing system depicted in FIG. 3;

FIG. 12 is a view depicting an example of a variation of the server management table, the disk management table, the hash table and the retry table when the state depicted in FIG. 3 varies into the state depicted in FIG. 11;

FIG. 13 is a view depicting an example of a variation of the server management table, the disk management table, the hash table and the retry table from the state depicted in FIG. 12;

FIG. 14 is a view depicting an example of a variation of the server management table, the disk management table, the hash table and the retry table from the state depicted in FIG. 13;

FIG. 15 is a view depicting an example of a variation of the server management table, the disk management table, the hash table and the retry table from the state depicted in FIG. 14;

FIG. 16 is a view depicting an example of a variation of the server management table, the disk management table, the hash table and the retry table when a load to storage servers decreases in the information processing system depicted in FIG. 11;

FIG. 17 is a view depicting an example of a variation of the server management table, the disk management table, the hash table and the retry table from the state depicted in FIG. 16;

FIG. 18 is a view depicting an example of a variation of the server management table, the disk management table, the hash table and the retry table from the state depicted in FIG. 17;

FIG. 19 is a flow chart illustrating an example of operation of the controlling apparatus depicted in FIG. 3;

FIG. 20 is a flow chart illustrating an example of a process at step S200 (addition process of FESV) depicted in FIG. 19;

FIG. 21 is a flow chart illustrating an example of a process at step S250 (deletion process of FESV) depicted in FIG. 19;

FIG. 22 is a flow chart illustrating an example of a process at step S300 (addition process of SSV) depicted in FIG. 19;

FIG. 23 is a flow chart illustrating an example of a process at step S400 (division process) depicted in FIG. 22;

FIG. 24 is a flow chart illustrating an example of a process at step S350 (deletion process of SSV) depicted in FIG. 19;

FIG. 25 is a flow chart illustrating an example of a process at step S450 (coupling process) depicted in FIG. 24;

FIG. 26 is a flow chart illustrating an example of operation of the front end server depicted in FIG. 3;

FIG. 27 is a flow chart illustrating an example of a process at step S600 (readout process) depicted in FIG. 26;

FIG. 28 is a flow chart illustrating an example of a process at step S700 (writing process) depicted in FIG. 26;

FIG. 29 is a flow chart illustrating an example of a process at step S800 (flash process) depicted in FIG. 26; and

FIG. 30 is a view depicting an example of an effect when the numbers of front end servers and storage servers are changed in the information processing system depicted in FIG. 3.

### DESCRIPTION OF EMBODIMENTS

There is a tendency that the power consumption of a computer system increases as the scale of a computer system increases. Therefore, it is desirable to reduce useless power consumption in the computer system in accordance with a variation of the load applied to the computer system.

It is an object of the present embodiments to reduce the power consumption of an information processing system without degradation of the processing performance by changing the number of information processing apparatus in a deactivated state in response to a variation of the load.

In the following, embodiments are described with reference to the drawings.

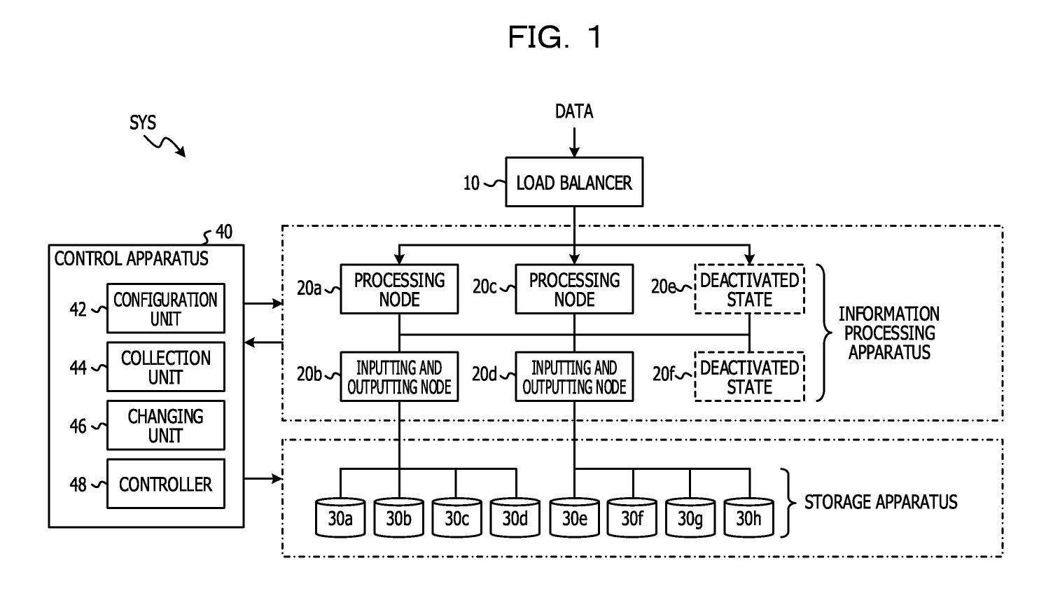

FIG. 1 is a block diagram depicting an information processing system of an embodiment. An information processing system SYS depicted in FIG. 1 includes a load balancer 10, a plurality of information processing apparatus 20 (20a, 20b, 20c, 20d, 20e and 20f), a plurality of storage apparatus 30 (30a, 30b, 30c, 30d, 30e, 30f, 30g and 30h) and a control apparatus 40 configured to control the information processing apparatus 20 and the storage apparatus 30. Each of the information processing apparatus 20 is one of processing nodes 20a and 20c configured to process data, inputting and outputting nodes 20b and 20d configured to input and output data processed by the processing nodes 20a and 20c for the storage apparatus 30, and information processing apparatus 20e and 20f that are in a deactivated state. The power supply to the information processing apparatus 20e and 20f in a deactivated state is blocked or the information processing apparatus 20e and 20f are set to a low power mode such as a stand-by state. Therefore, the power consumption of the information processing apparatus 20e and 20f is lower than the power consumptions of the processing nodes 20a and 20c and the inputting and outputting nodes 20b and 20d.

The load balancer 10 distributes data received from the outside to the processing nodes 20a and 20c. In the example depicted in FIG. 1, the storage apparatus 30a to 30d are coupled to the inputting and outputting node 20b and the storage apparatus 30e to 30h are coupled to the inputting and outputting node 20d.

The control apparatus 40 includes a configuration unit 42, a collection unit 44, a changing unit 46 and a controller 48. The configuration unit 42 selects a first given number of information processing apparatus 20a and 20c from among the information processing apparatus 20 as processing nodes and selects a second given number of information processing apparatus 20b and 20d as inputting and outputting nodes. Further, the configuration unit 42 couples a third given number of storage apparatus 30a to 30d and 30e to 30h from among the plurality of storage apparatus 30 to the selected inputting and outputting nodes 20b and 20d, respectively.

The collection unit 44 collects, from each of the processing nodes 20a and 20c and each of the inputting and outputting nodes 20b and 20d, load information indicative of the load to the nodes. The changing unit 46 changes the number of the processing nodes 20a and 20c or the number of inputting and outputting nodes 20b and 20d on the basis of the load information collected by the collection unit 44. The controller 48 sets the information processing apparatus 20e and 20f not selected as a processing node or an inputting and outputting node from among the plurality of information processing apparatus 20 to a deactivated state.

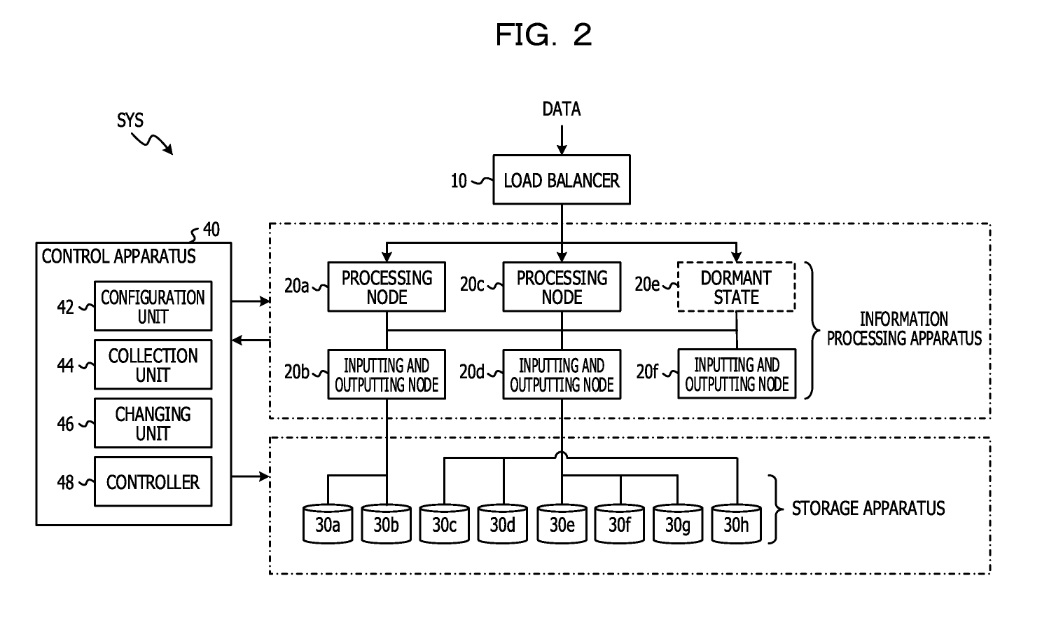

FIG. 2 is a block diagram depicting an example of a state when the load to the inputting and outputting nodes 20b and 20d increases in the information processing system SYS depicted in FIG. 1. For example, the collection unit 44 detects that the load to at least one of the inputting and outputting nodes 20b and 20d exceeds a first threshold value. The changing unit 46 decides, on the basis of the load information received from the collection unit 44, that the performance of one of the inputting and outputting nodes 20b and 20d makes a bottle neck and therefore the processing performance of the information processing system SYS is degraded thereby. Thus, the changing unit 46 selects the information processing apparatus 20f in a deactivated state as an inputting and outputting node.

Further, the changing unit 46 reassigns the storage apparatus 30c and 30d coupled to the inputting and outputting node 20b to the inputting and outputting node 20f and reassigns the storage apparatus 30h coupled to the inputting and outputting node 20d to the inputting and outputting node 20f. For example, the changing unit 46 executes a reassignment process of the storage apparatus 30 so that the numbers of storage apparatus 30 coupled to the inputting and outputting nodes 20b, 20d and 20f may become substantially equal to each other. Further, the changing unit 46 starts up the newly selected inputting and outputting node 20f. It is to be noted that the startup of the inputting and outputting node 20f may be executed alternatively by the controller 48. Consequently, the bottle neck in the performance of the inputting and outputting nodes 20b and 20d disappears and degradation of the processing performance of the information processing system SYS is suppressed.

On the other hand, the collection unit 44 detects that, in the state depicted in FIG. 2, the load to at least one of the inputting and outputting nodes 20b, 20d and 20f becomes lower than a second threshold value that is lower than the first threshold value. The changing unit 46 decides, on the basis of the load information received from the collection unit 44, that there is a sufficient room in the processing performance of the inputting and outputting nodes 20b, 20d and 20f and useless power is consumed, and releases the selection of the information processing apparatus 20f as an inputting and outputting node. The controller 48 sets the information processing apparatus 20f with regard to which the selection as an inputting and outputting node is released to a deactivated state.

Further, the changing unit 46 reassigns the storage apparatus 30c and 30d coupled to the inputting and outputting node 20f to the inputting and outputting node 20b and reassigns the storage apparatus 30h coupled to the inputting and outputting node 20f to the inputting and outputting node 20d. Consequently, the information processing system SYS is placed into the state depicted in FIG. 1 and the processing performance of the information processing system SYS is set to a suitable performance corresponding to reduction of the load. Further, by setting the information processing apparatus 20f to a deactivated state, the power consumption of the information processing system SYS is reduced while a suitable processing performance is maintained.

It is to be noted that, if the collection unit 44 detects that, in the state depicted in FIG. 1, the load to at least one of the processing nodes 20a and 20c exceeds a third threshold value, then the changing unit 46 sets the information processing apparatus 20e in a deactivated state to a processing node. Consequently, the bottle neck in the performance of the processing nodes 20a and 20c is cancelled and degradation of the processing performance of the information processing system SYS is suppressed.

On the other hand, it is assumed that, when the information processing apparatus 20e operates as a processing node, the collection unit 44 detects that the load to at least one of the processing nodes 20a, 20c and 20e becomes lower than a fourth threshold value that is lower than the third threshold value. In this case, the changing unit 46 releases, for example, selection of the information processing apparatus 20e as a processing node. The controller 48 sets the information processing apparatus 20e with regard to which the selection as a processing node is released to a deactivated state. Consequently, the information processing system SYS is placed into the state depicted in FIG. 1 and the processing performance of the information processing system SYS is set to a suitable performance corresponding to reduction of the load. Further, by setting the information processing apparatus 20e to a deactivated state, the power consumption of the information processing system SYS is reduced while a suitable processing performance is maintained.

In this manner, in the embodiment depicted in FIGS. 1 and 2, by changing the number of processing nodes or the number of inputting and outputting nodes in response to a variation of the load to the processing nodes and the inputting and outputting nodes, the power consumption is reduced without degrading the processing performance of the information processing system SYS. In other words, by changing the number of information processing apparatus 20 in a deactivated state in response to a variation of the load to the processing nodes and the inputting and outputting nodes, the power consumption is reduced without degrading the processing performance of the information processing system SYS.

When the number of inputting and outputting nodes is changed, by reassigning the storage apparatus 30 coupled to the inputting and outputting nodes, the number of storage apparatus 30 coupled to the inputting and outputting nodes is set suitably in accordance with the performance of the inputting and outputting nodes. Consequently, the bottle neck in the performance of the inputting and outputting nodes is cancelled and degradation of the processing performance of the information processing system SYS is suppressed.

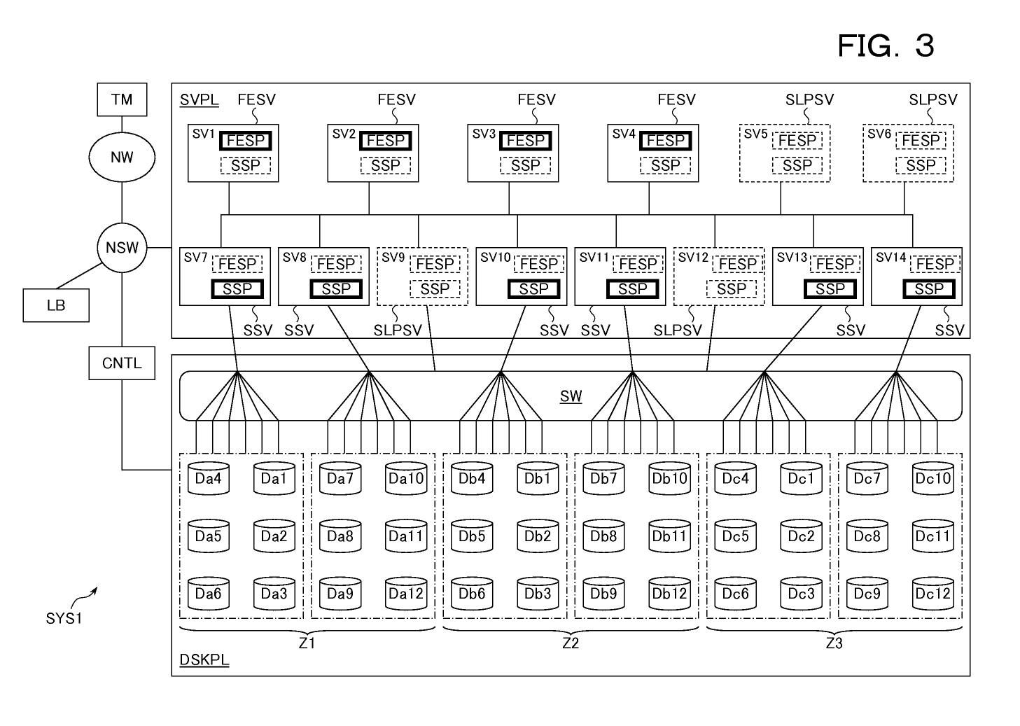

FIG. 3 is a block diagram depicting another embodiment of an information processing system, a controlling method for the information processing system, and a controlling program of a controlling apparatus. An information processing system SYS1 depicted in FIG. 3 includes a load balancer LB, a network switch NSW, a control apparatus CNTL, a server pool SVPL and a disk pool DSKPL. The information processing system SYS1 functions as a network storage system and is used, for example, for an object storage service in which data is managed as an object, a cloud storage service constructed by an object storage, or the like. Where the control apparatus CNTL, the load balancer LB, the server pool SVPL and the disk pool DSKPL are coupled with each other through a local area network (LAN), the network switch NSW is a LAN switch such as a layer 2 switch.

The information processing system SYS1 is coupled to a terminal apparatus TM through a network NW such as the Internet or an intranet. It is to be noted that the information processing system SYS1 may be coupled to the terminal apparatus TM without the intervention of the network NW. The terminal apparatus TM is included in a computer apparatus that executes an application program in which the information processing system SYS1 is used as a network storage system. The information processing system SYS1 executes writing, readout, deletion and so forth of data into or from disk apparatus D (Da, Db, and Dc) in the disk pool DSKPL on the basis of an instruction from a user who operates the terminal apparatus TM. It is to be noted that the number of the terminal apparatus TM to be coupled to the information processing system SYS1 through the network NW is not limited to one but a plurality of terminal apparatus TM may be coupled.

The server pool SVPL includes a plurality of servers SV (SV1 to SV14). Each of the servers SV is an example of an information processing apparatus. It is to be noted that the number of the servers SV included in the server pool SVPL is not limited to 14. If a front end service program FESP is started up, then each of the servers SV operates as a front end server FESV that processes an access request from the terminal apparatus TM or the like. The front end server FESV is an example of a processing node that processes an access request (query) and data distributed by the load balancer LB.

If a storage service program SSP is started up, then each of the servers SV operates as a storage server SSV (back end server) that controls access to the disk apparatus D (Da, Db, Dc) in the disk pool DSKPL. The storage server SSV is an example of an inputting and outputting node that inputs and outputs data processed by the front end server FESV to the disk apparatus Da (Da1 to Da12), Db (Db1 to Db12) and Dc (Dc1 to Dc12). It is to be noted that the front end service program FESP and the storage service program SSP are started up exclusively with each other.

The servers SV1 to SV14 are physically coupled with each other and are physically coupled with a switching apparatus SW in the disk pool DSKPL. Consequently, each of the servers SV1 to SV14 can operate as both of a front end server FESV and a storage server SSV.

In FIG. 3, each front end service program FESP indicated by a thick frame and each storage service program SSP indicated by a thick frame indicate that they are operating. Each front end service program FESP indicated by a broken line frame and each storage service program SSP indicated by a broken line frame indicate that they are not operating.

Each server SV indicated by a broken line frame indicates a server in a deactivated state (sleep server SLPSV) with regard to which operation stops. Each sleep server SLPSV is in a shutdown state in which the power supply is blocked. It is to be noted that the sleep server SLPSV may be set to a sleep state such as a hibernation state in which starting up time is shorter than that from a shutdown state or to a standby state. Alternatively, the sleep server SLPSV may be set such that the frequency of an operation clock is lower than that in a normal state. Where the sleep server SLPSV is set to a shutdown state or a deactivated state such as a sleep state, the sleep server SLPSV is in a state in which the power consumption is lower than that of the front end server FESV and the storage server SSV.

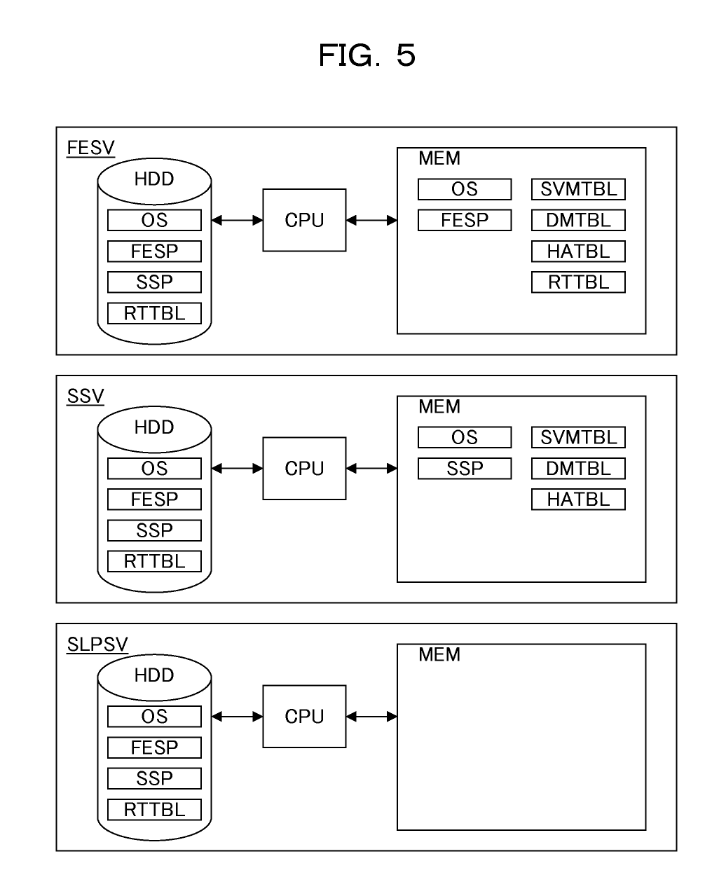

It is to be noted that the sleep server SLPSV may execute some other application program than the front end service program FESP and the storage service program SSP. Since the sleep server SLPSV that executes some other application program is not included in the network storage system, the power consumption of the network storage system is reduced. An example of the front end server FESV, the storage server SSV and the sleep server SLPSV is depicted in FIG. 5.

The front end server FESV controls, on the basis of an access request received from the terminal apparatus TM through the load balancer LB, the storage servers SSV so that the storage servers SSV and the disk apparatus D as a network storage. The request from the terminal apparatus TM includes a writing request of data, a readout request of data or a deletion request of data.

If the access request is a writing request, then the front end server FESV outputs data associated with the writing request and a writing request for writing the data into the disk apparatus Da, Db or Dc to a storage server SSV. If the access request is a readout request, then the front end server FESV outputs a request for reading out data from one of the disk apparatus Da, Db and Dc to one of the storage servers SSV.

The storage server SSV interprets a writing request (query) and data from the front end server FESV and inputs the data to the disk apparatus D (Da, Db or Dc) allocated to a zone Z (Z1, Z2, and Z3) to which the storage server SSV belongs. While, in the example depicted in FIG. 3, two storage servers SSV belong to the same zone Z, the zone may be set for each of the storage servers SSV.

The storage server SSV interprets a readout request (query) from the front end server FESV and reads out data from the disk apparatus D (Da, Db or Dc) allocated to the zone Z belonging to the storage server SSV. The storage server SSV returns the data read out from the disk apparatus D to the front end server FESV. If the access request is a deletion request, then the front end server FESV outputs a deletion request for deleting data stored in the disk apparatus Da, Db and Dc to the storage server SSV.

The disk pool DSKPL includes a plurality of disk apparatus Da (Da1 to Da12), Db (Db1 to Db12) and Dc (Dc1 to Dc12) and a switching apparatus SW. It is to be noted that the number of disk apparatus D (Da, Db and Dc) included in the disk pool DSKPL is not limited to 36. The disk apparatus D is an example of a storage apparatus. In FIG. 3, a frame indicated by an alternate long and short dash line indicates an example of an enclosure in which the disk apparatus D are accumulated. It is to be noted that the number of disk apparatus D accumulated in each enclosure is not limited to 6 depicted in FIG. 3.

Each disk apparatus D may be a hard disk drive (HDD) or a solid state drive (SSD) apparatus. The disk apparatus Da (Da1 to Da12) are allocated to a zone Z1; the disk apparatus Db (Db1 to Db12) are allocated to another zone Z2; and the disk Dc (Dc1 to Dc12) are allocated to a further zone Z3.

The information processing system SYS1 redundantly stores one data transferred from the terminal apparatus TM into the disk apparatus Da, Db and Dc in the three zones Z1, Z2 and Z3. In other words, three replica data are stored into the disk pool DSKPL. The number of replica data may be two or more, and the number of zones Z1 to Z3 may be greater than that of the replica data.

Power supply systems to the disk apparatus Da, Db and Dc allocated to the zones Z1, Z2 and Z3 may be independent of each other. In this case, even if one or two power supply systems fail, access to one of the three replica data can be performed and the reliability of the information processing system SYS1 is enhanced.

Further, a given number of servers SV in the server pool SVPL may be coupled in advance to each of the power supply systems in the zones Z1 to Z3. In this case, the servers SV coupled to the power supply system for the zone Z1 are started up as the storage servers SSV coupled to the disk apparatus Da. The servers SV coupled to the power supply system for the zone Z2 are started up as the storage servers SSV coupled to the disk apparatus Db. The servers SV coupled to the power supply system for the zone Z3 are started up as the storage servers SSV coupled to the disk apparatus Dc.

The switching apparatus SW includes ports coupled to the servers SV and ports coupled to the disk apparatus D. The switching apparatus SW is controlled by the control apparatus CNTL, and couples a storage server SSV to a given disk apparatus D or blocks coupling between a storage server SSV and a disk apparatus D.

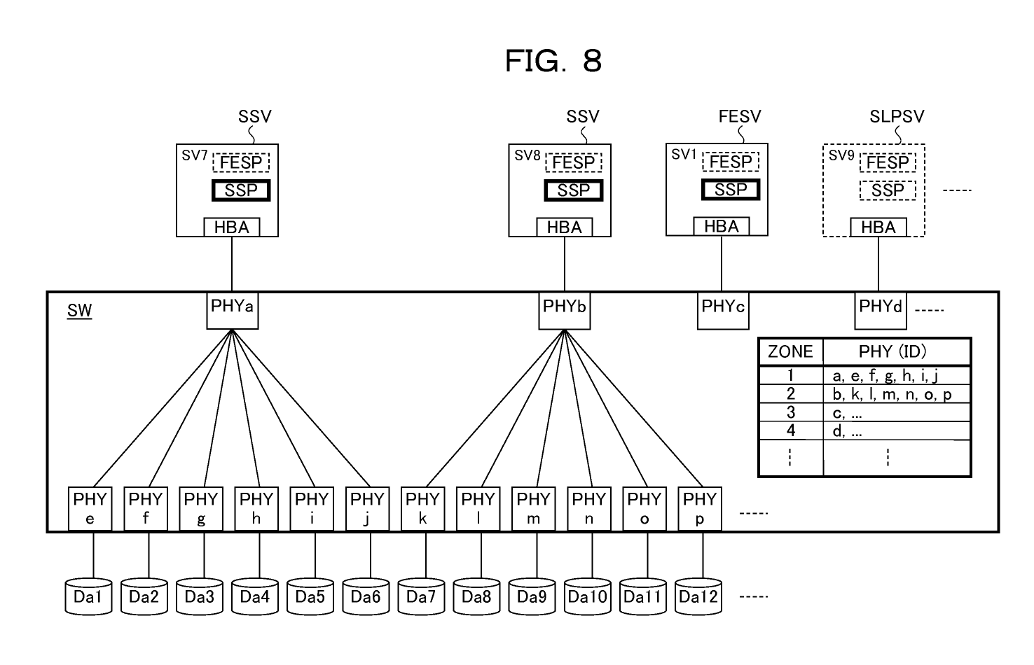

In the example depicted in FIG. 3, the storage server SSV (SV7) is coupled with the disk apparatus Da1 to Da6 allocated to the zone Z1 through the switching apparatus SW. The storage server SSV (SV8) is coupled with the disk apparatus Da7 to Da12 allocated to the zone Z1 through the switching apparatus SW. The storage server SSV (SV10) is coupled with the disk apparatus Db1 to Db6 allocated to the zone Z2 through the switching apparatus SW. The storage server SSV (SV11) is coupled with the disk apparatus Db7 to Db12 allocated to the zone Z2 through the switching apparatus SW. The storage server SSV (SV13) is coupled with the disk apparatus Dc1 to Dc6 allocated to the zone Z3 through the switching apparatus SW. The storage server SSV (SV14) is coupled with the disk apparatus Dc7 to Dc12 allocated to the zone Z3 through the switching apparatus SW. An example of the switching apparatus SW is depicted in FIG. 8.

The information processing system SYS1 functions as a dispersion object storage in which a plurality of disk apparatus D are handled as one storage apparatus. It is to be noted that the storage server SSV may be coupled with an internet small computer system interface (iSCSI) volume or the like using a storage area network (SAN).

The load balancer LB distributes an access request received from the terminal apparatus TM uniformly to the front end servers FESV and suppresses dispersion of the load to the front end servers FESV. The load balancer LB may be an apparatus for exclusive use or may be implemented by installing open source software (OSS) such as Nginx (registered trademark) into a general-purpose server. The load balancer LB is an example of a load balancer that distributes the load to the front end servers FESV. It is to be noted that the load balancer LB may be disposed at an arbitrary position on the network NW.

The control apparatus CNTL selects a server SV as one of a front end server FESV, a storage server SSV and a sleep server SLPSV. The server SV selected as a front end server FESV executes the front end service program FESP and operates as a front end server FESV. The server SV selected as a storage server SSV executes the storage service program SSP and operates as a storage server SSV. The control apparatus CNTL controls the switching apparatus SW to couple the selected storage server SSV with a given disk apparatus D. Further, the control apparatus CNTL controls increase and decrease of the number of front end servers FESV on the basis of the load to the front end servers FESV, and controls increase and decrease of the number of storage servers SSV on the basis of the load to the storage server SSV.

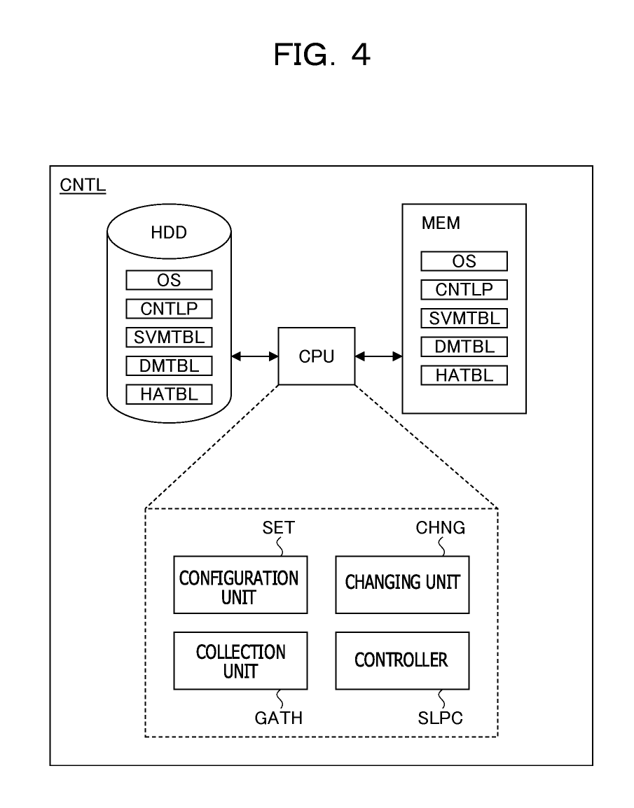

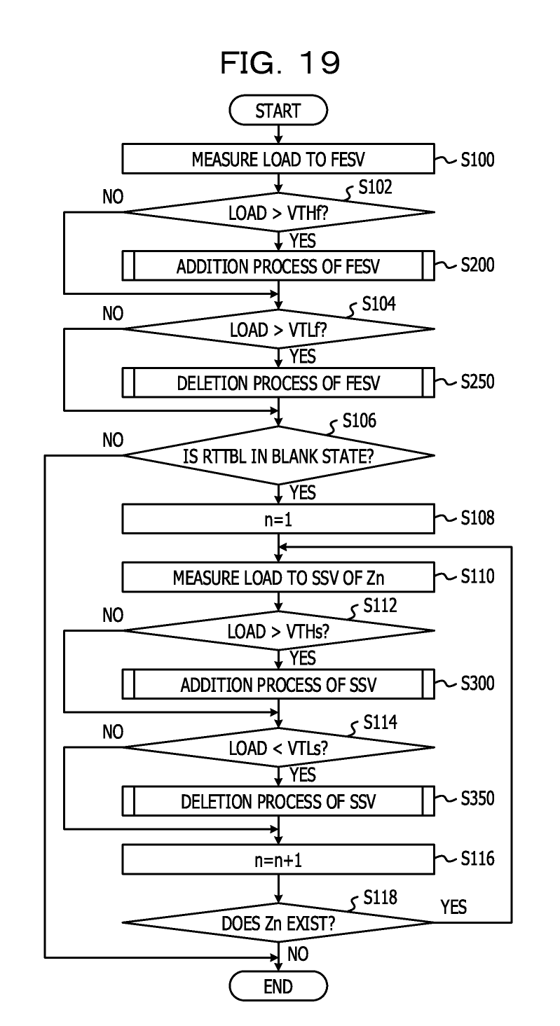

In this manner, the control apparatus CNTL controls coupling among the front end servers FESV, the storage servers SSV and the disk apparatus D to manage the configuration of the entire information processing system SYS1. An example of the control apparatus CNTL is depicted in FIG. 4, and an example of operation of the control apparatus CNTL is depicted in FIG. 19.

FIG. 4 is a block diagram depicting an example of the controlling apparatus CNTL depicted in FIG. 3. The control apparatus CNTL is a computer apparatus such as a server and includes a central processing unit (CPU), a memory MEM and a hard disk drive HDD. In the hard disk drive HDD, an operating system OS, a control program CNTLP, a server management table SVMTBL in an initial state or a blank state, a disk management table DMTBL and a hash table HATBL are stored in advance. It is to be noted that the control program CNTLP, the server management table SVMTBL, the disk management table DMTBL and the hash table HATBL may be stored in a nonvolatile storage device such as a read only memory (ROM).

The CPU loads the operating system OS into the memory MEM upon starting up (power on) of the control apparatus CNTL. Thereafter, the CPU transfers the control program CNTLP, the server management table SVMTBL, the disk management table DMTBL and the hash table HATBL to the memory MEM. Then, the CPU executes the control program CNTLP on the memory MEM to implement functions of the control apparatus CNTL.

Where the configuration of the information processing system SYS1 is set different from that of the server management table SVMTBL and the disk management table DMTBL in an initial state, the CPU may create a server management table SVMTBL and a disk management table DMTBL in accordance with the new configuration. Further, the CPU may create a hash table HATBL in accordance with the new configuration.

It is to be noted that, where the server management table SVMTBL, the disk management table DMTBL in an initial state or a blank state and the hash table HATBL are not stored in the hard disk drive HDD, the tables may be created in the memory MEM by the control program CNTLP.

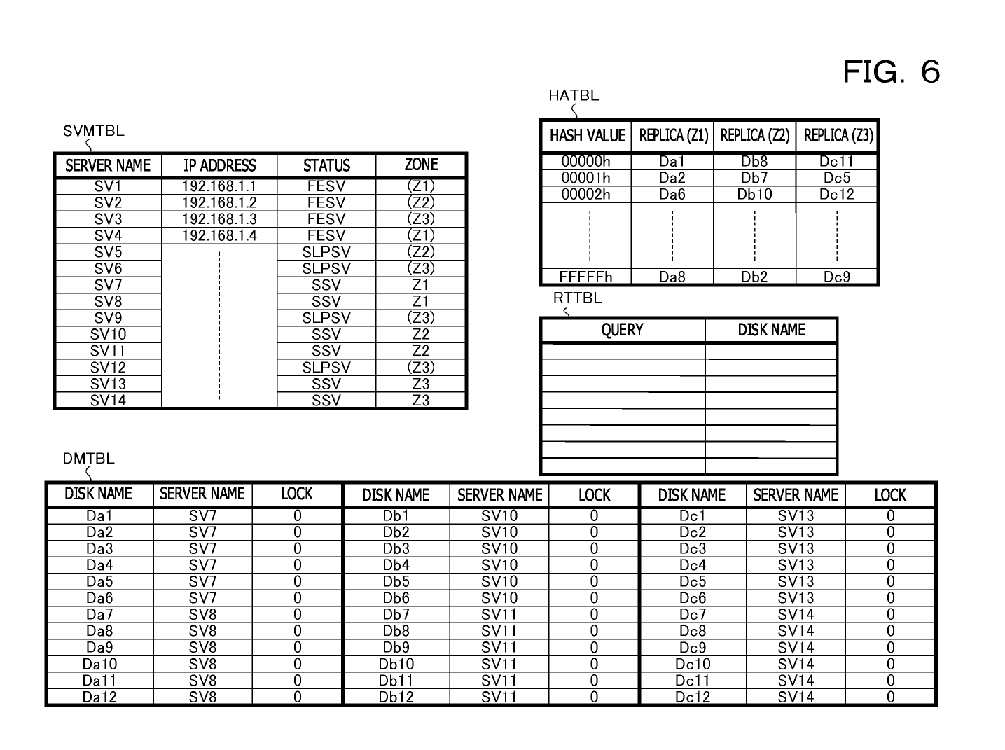

In the server management table SVMTBL, information representative of to which one of a front end server FESV, a storage server SSV and a sleep server SLPSV each server SV is to be set is placed. In the disk management table DMTBL, information representative of the storage server SSV coupled with each of the disk apparatus D is stored. In the hash table HATBL, information representative of disk apparatus Da, Db and Dc corresponding to individual hash values is placed. An example of the server management table SVMTBL, the disk management table DMTBL and the hash table HATBL is depicted in FIG. 6.

The CPU operates as a configuration unit SET that executes a control program CNTLP to select a front end server FESV and a storage server SSV and couple a given number of disk apparatus D to each storage server SSV. By operation of the configuration unit SET, the information processing system SYS1 is set to an initial state illustrated in FIG. 3.

Further, the CPU operates as a collection unit GATH that collects load information representative of the load to the front end servers FESV and the storage servers SSV. Further, the CPU operates as a changing unit CHNG that changes the number of front end servers FESV and the number of storage servers SSV, on the basis of the collected load information.

Further, the CPU operates as a controller SLPC that sets a server SV that is not selected as any of a front end server FESV and a storage server SSV to a deactivated state (sleep server SLPSV). The configuration unit SET, the changing unit CHNG and the controller SLPC operate on the basis of information set to the server management table SVMTBL and the disk management table DMTBL. Further, the CPU that executes the control program CNTLP has a function that transfers the server management table SVMTBL, the disk management table DMTBL and the hash table HATBL to a front end server FESV and a storage server SSV.

FIG. 5 is a block diagram depicting an example of the front end server FESV, the storage server SSV and the sleep server SLPSV depicted in FIG. 3.

The front end server FESV, the storage server SSV and the sleep server SLPSV individually include a CPU, a memory MEM and a hard disk drive HDD. The hard disk drive HDD has stored therein in advance an operating system OS, a front end service program FESP, a storage service program SSP and a retry table RTTBL that is blank. It is to be noted that the front end service program FESP, the storage service program SSP and the blank retry table RTTBL may otherwise be stored in a nonvolatile storage device such as a ROM.

The sleep server SLPSV is in state in which its operation stops and effective programs and information are not stored in the memory MEM. If the sleep server SLPSV is changed to a front end server FESV, then the CPU of the front end server FESV loads the operating system OS into the memory MEM. Thereafter, the CPU transfers the front end service program FESP and the empty retry table RTTBL from the hard disk drive HDD to the memory MEM. Then, the CPU executes the front end service program FESP on the memory MEM to implement the functions of the front end server FESV. The CPU that executes the front end service program FESP receives and stores the server management table SVMTBL, the disk management table DMTBL and the hash table HATBL transferred thereto from the control apparatus CNTL into the memory MEM.

When the sleep server SLPSV is to be changed to a storage server SSV, the CPU of the storage server SSV loads the operating system OS into the memory MEM. Thereafter, the CPU transfers the storage service program SSP from the hard disk drive HDD to the memory MEM. Then, the CPU executes the storage service program SSP on the memory MEM to implement the functions of the storage server SSV. The CPU that executes the storage service program SSP receives and stores the server management table SVMTBL, the disk management table DMTBL and the hash table HATBL transferred thereto from the control apparatus CNTL into the memory MEM.

FIG. 6 is a view depicting an example of the server management table SVMTBL, the disk management table DMTBL, the hash table HATBL and the retry table RTTBL depicted in FIGS. 4 and 5. The server management table SVMTBL, the disk management table DMTBL, the hash table HATBL and the retry table RTTBL depicted in FIG. 6 are information on the memory MEM depicted in FIGS. 4 and 5 and depict a state of the information processing system SYS1 depicted in FIG. 3. It is to be noted that the retry table RTTBL is included in the front end servers FESV but is not included in the control apparatus CNTL and the storage servers SSV.

The server management table SVMTBL is used to manage the state of the servers SV. The server management table SVMTBL includes a plurality of regions, in which a server name, an internet protocol (IP) address, a status and a zone are to be placed, for each of the servers SV1 to SV14.

In the server management table SVMTBL, information such as a name, an identification (ID) or the like for identifying each server SV is placed in the region for the server name. In the region for the IP address, a number (IP address) for specifying each server SV on the network is placed. In the region for the status, information representative of to which one of a front end server FESV, a storage server SSV and a sleep server SLPSV each server SV is placed. In the region for the zone, information representative of a zone of the disk apparatus D coupled with each storage server SSV is placed.

Where a server SV is set to a front end server FESV or a sleep server SLPSV, information representative of a dummy zone (one of Z1 to Z3) is placed in the region for the zone. In FIG. 6, the information indicating the dummy zone is indicated in parenthesis. In the server management table SVMTBL, the regions for the status and the zone are changed on the basis of addition/deletion of a front end server FESV or a storage server SSV during operation of the information processing system SYS1.

The disk management table DMTBL is used to manage coupling between the storage servers SSV and the disk apparatus D and is used to manage the lock state of the disk apparatus D. The disk management table DMTBL includes, for each of the disk apparatus Da1 to Da12, Db1 to Db12 and Dc1 to Dc12, a plurality of regions for placing information indicative of a disk name, a server name and a lock.

In the region for the disk name, information such as a name or an ID for identifying each disk apparatus D is placed. In the region for the server name, information representative of a server SV (storage server SSV) coupled with each disk apparatus D is placed. In the region for the lock, information representative of a state in which each disk apparatus D is in a locked state (=1) or another state in which each disk apparatus D is in an unlocked state (=0) is placed. The region for the lock is set to “1” when a front end server FESV is to suspend inputting and outputting of data to and from each disk apparatus D during execution of a process for addition or deletion of a storage server SSV. In the disk management table DMTBL, the regions for the server name and the lock are changed on the basis of addition/deletion of a front end server FESV or a storage server SSV during operation of the information processing system SYS1.

It is to be noted that the disk management table DMTBL may include a region for placing a unique value for identifying each disk apparatus D therein. The unique value is a SAS (serial attached SCSI (small computer system interface)) address in SAS. Alternatively, the unique value is iSCSI qualified name (IQN) in iSCSI or the like. By placing a unique value for identifying each disk apparatus D into the disk management table DMTBL, addition and deletion of a disk apparatus D can be executed in a simple and easy procedure in comparison with an alternative case in which a unique value is not used.

The retry table RTTBL is used to register an access to a disk apparatus D in a locked state and write data into a disk apparatus D whose lock is canceled. The retry table RTTBL includes a plurality of regions for placing information indicative of a query and a disk name. In an initial state immediately after the front end server FESV is started up, the retry table RTTBL is blank. Into the retry table RTTBL, information representative of a writing request issued during processing for adding a storage server SSV or during processing for deleting an a storage server SSV is placed.

In the retry table RTTBL, into the region for the query, information representative of a query that is information indicative of a path for data when a writing access request to a disk apparatus D in a locked state is placed. The path for data is a path for a uniform resource locator (URL), which is used in the hypertext transfer protocol (HTTP) by the information processing system SYS1, or like data. The path for data is included in a method of “PUT,” “GET” and so forth transmitted from the terminal apparatus TM.

In the retry table RTTBL, into the region for the disk name, information indicative of a disk apparatus D in a locked state for which data writing is suspended is placed. The information to be placed in the retry table RTTBL increases on the basis of a writing access request to a disk apparatus D in a locked state but decreases on the basis of writing of data into a disk apparatus D whose lock is canceled.

The hash table HATBL is used to determine a disk apparatus D of an access destination for data on the basis of a hash value obtained by a hash function. For example, the front end server FESV generates a hash value of 128 bits using message digest 5 (MD5) as the hash function. The hash table HATBL includes, for each hash value, a plurality of regions for placing a given number of bits in a hash value obtained by a hash function and information indicative of three disk apparatus Da, Db and Dc allocated for each hash value. In short, the information processing system SYS1 places three replica data redundantly into the disk apparatus Da, Db and Dc allocated to three zones Z1 to Z3.

The reference character h indicated at the tail end of each hash value indicates that the hash value is a hexadecimal number. In the example depicted in FIG. 6, each hash value placed in the hash table HATBL is represented by 20 bits. However, the bit number of the hash value is not limited to 20 bits. It is to be noted that hash values different from each other may be allocated to each disk apparatus D.

In the information processing system SYS1 depicted in FIG. 3, the number of disk apparatus D coupled with the switching apparatus SW and the number of disk apparatus D allocated to the zones Z1, Z2 and Z3 are not changed during operation of the information processing system SYS1. Therefore, the hash table HATBL is not changed during operation of the information processing system SYS1. It is to be noted that, if the number of disk apparatus D coupled with the switching apparatus SW or the number of disk apparatus D allocated to the zones Z1, Z2 and Z3 is changed during operation of the information processing system SYS1, then the hash table HATBL may be changed during operation of the information processing system SYS1.

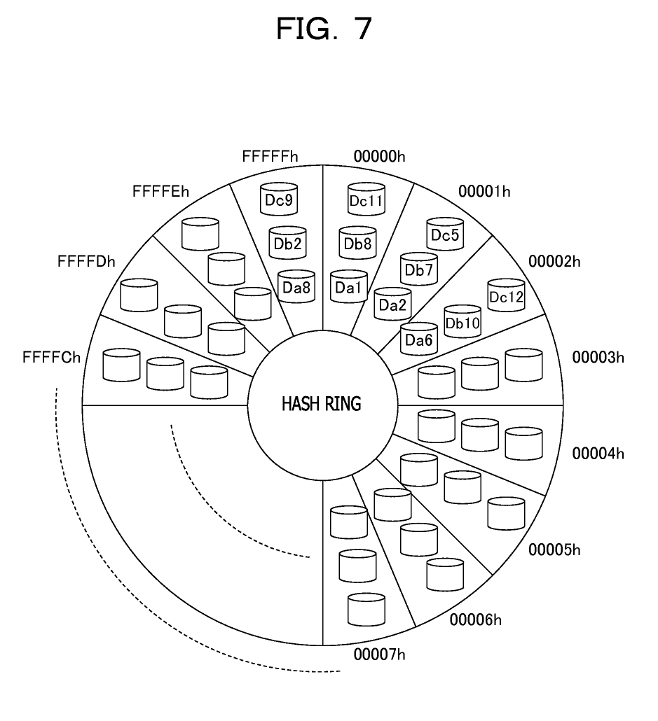

FIG. 7 is a view depicting an example of a hash space indicated by the hash table HATBL depicted in FIG. 6. For example, the information processing system SYS1 adopts a consistent hash method and the hash space is indicated as a hash ring. The front end server FESV determines three disk apparatus Da, Db and Dc into or from which data is to be written or read out in response to a hash value obtained by inputting an identifier for identifying data (for example, a path name or a file name of the data) to a hash function. Since the hash function outputs hash values distributed uniformly, data are stored to all disk apparatus D in a distributed manner.

FIG. 8 is a view depicting an example of the switching apparatus SW depicted in FIG. 3. For example, the switching apparatus SW includes a SAS expander. The switching apparatus SW includes a plurality of input/output interfaces PHY (PHYa, PHYb, PHYc and PHYd) coupled individually to interface cards HBA (host bus adapter) of the serves SV (SSV, FESV and SLPSV). Further, the switching apparatus SW includes a plurality of input/output interfaces PHY (PHYe, PHYf, . . . , PHYo and PHYp) each coupled with a disk apparatus D.

The switching apparatus SW includes a zone corresponding to each storage server SSV, another zone corresponding to a front end server FESV that is not coupled with a disk apparatus D, and a further zone corresponding to a sleep server SLPSV that is not coupled with a disk apparatus D. In the example depicted in FIG. 8, the storage server SSV (SV7) and the disk apparatus Da1 to Da6 are allocated to the zone 1, and another storage server SSV (SV8) and the disk apparatus Da7 to Da12 are allocated to the zone 2. Further, the front end server FESV (SV1 and so forth) is set to the zone 3, and the sleep server SLPSV (SV9 and so forth) is allocated to the zone 4. It is to be noted that the zones indicated in FIG. 8 are different from the zones Z1 to Z3 depicted in FIG. 3.

The switching apparatus SW changes servers SV and disk apparatus D to be allocated to each zone on the basis of an instruction from the control apparatus CNTL on the basis of addition/deletion of a storage server SSV or a front end server FESV. For example, changing of servers SV and disk apparatus D to be allocated to each zone is executed by the control apparatus CNTL issuing a serial management protocol (SMP) command to the switching apparatus SW.

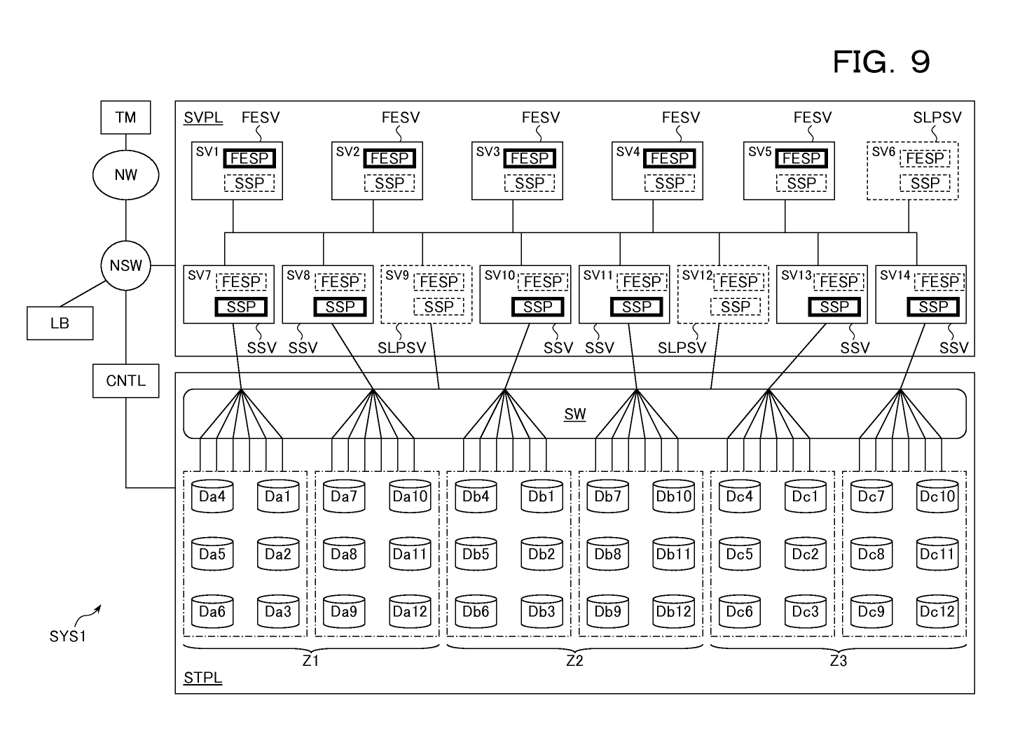

FIG. 9 is a view depicting an example of a state when the load to the front end servers FESV increases in the information processing system SYS1 depicted in FIG. 3. For example, the load to the front end servers FESV increases when a large quantity of writing requests or reading out requests of data whose size is small like text data is received from the load balancer LB. This is because, when the data size is small, the performance of the network NW and the storage server SSV does not make a bottle neck but the performance of the front end server FESV makes a bottle neck.

The collection unit GATH of the control apparatus CNTL depicted in FIG. 4 measures the load to each front end server FESV (SV1 to SV4) in a given cycle, and decides a high load state in which there is no room on the ability of the front end server FESV when the load exceeds a given threshold value VTHf. For example, the collection unit GATH determines the load to each front end server FESV on the basis of the utilization rate of the CPU and decides a high load state when the utilization rate of the CPU exceeds 85% (VTHf).

The changing unit CHNG selects, when the collection unit GATH decides a high load state, one of the sleep servers SLPSV (SV5) and causes the selected sleep server SLPSV to execute the front end service program FESP thereby to increase the number of the front end servers FESV. Further, the changing unit CHNG notifies the load balancer LB of information of the newly started up front end server FESV. The load balancer LB adds the front end server FESV whose notification is received to the dispersion destination of data. Then, the information processing system SYS1 is set to a state illustrated in FIG. 9 from the state illustrated in FIG. 3. In this manner, when the load to the front end servers FESV increases, a new front end server FESV is added to decrease the load per one front end server FESV. Consequently, the processing performance by the front end servers FESV is improved and the bottle neck in performance of the front end server FESV disappears.

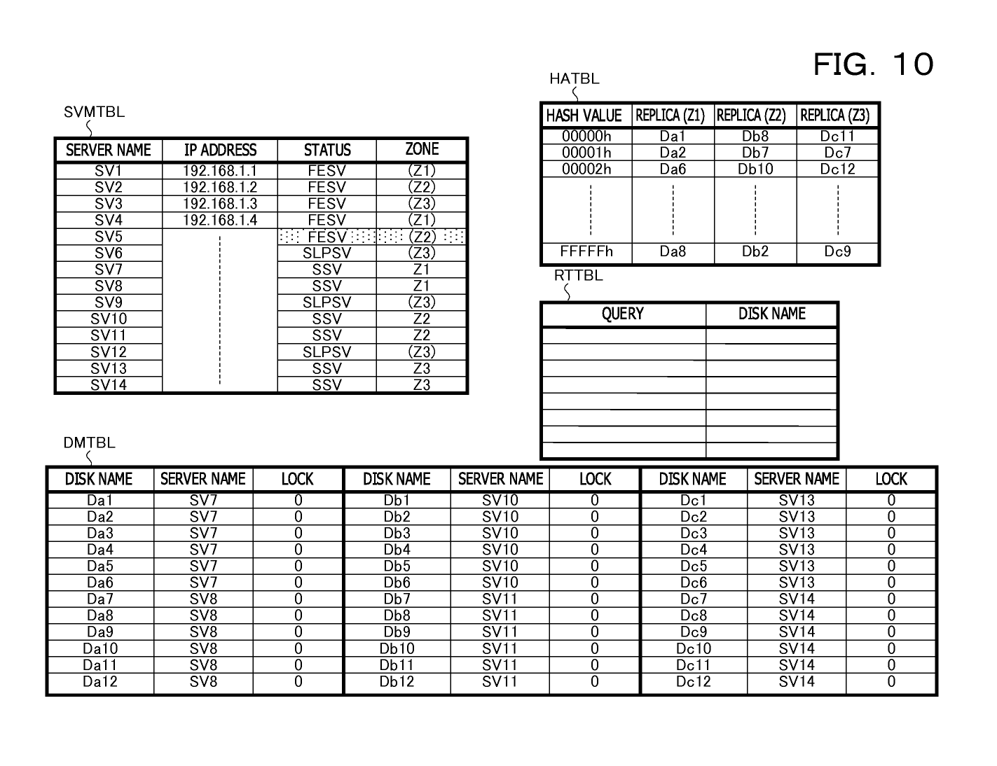

FIG. 10 is a view depicting an example of the server management table SVMTBL, the disk management table DMTBL, the hash table HATBL and the retry table RTTBL in the information processing system SYS1 depicted in FIG. 9. A site at which the state is different from the state illustrated in FIG. 6 is indicated by shading. It is to be noted that the retry table RTTBL is included in the front end servers FESV but is not included in the control apparatus CNTL and the storage servers SSV.

When the server SV5 is to be changed from a sleep server SLPSV to a front end server FESV, the changing unit CHNG of the control apparatus CNTL depicted in FIG. 4 changes the status of the server SV5 in the server management table SVMTBL from “SLPSV” to “FESV.” Then, the changing unit CHNG transfers the changed server management table SVMTBL to all front end servers FESV and all storage servers SSV so that the server management table SVMTBL is updated.

It is to be noted that, if the load applied to the front end servers FESV (SV1 to SV4) becomes lower than a threshold value VTLf that is lower than the threshold value VTHf, then the collection unit GATH of the control apparatus CNTL decides a low load state in which there is a sufficient room on the capability of the front end servers FESV. For example, the load to the front end servers FESV decreases if a writing request or a reading out request for data having a large size such as image data is received from the load balancer LB. This is because, when the data size is great, the performance of the network NW makes a bottle neck and a room is generated on the capability of the front end server FESV.

The collection unit GATH determines the load to the front end servers FESV on the basis of the utilization rate of the CPU and decides a low load state, for example, when the utilization rate of the CPU is lower than 30% (VTLf). The low load state of the front end servers FESV is a state in which the performance of the front end servers FESV does not make a bottle neck even if the number of front end servers FESV is decreased by one.

If the collection unit GATH decides a low load state of the front end servers FESV, then the changing unit CHNG stops operation of one of the front end servers FESV and sets the one front end server FESV to a sleep server SLPSV to decrease the number of front end servers FESV. In other words, selection of one front end server FESV is released. Further, the changing unit CHNG notifies the load balancer LB of information of the front end server FESV whose operation is stopped. The load balancer LB deletes the front end server FESV, with regard to which the notification is received, from the distribution destination of data.

For example, by decrease of the number of front end servers FESV, the information processing system SYS1 enters the state depicted in FIG. 3 from the state depicted in FIG. 9, and the server management table SVMTBL, the disk management table DMTBL, the hash table HATBL and the retry table RTTBL are set to the state illustrated in FIG. 6.

By switching a front end server FESV (SV5) to a sleep server SLPSV on the basis of decrease of the load to the front end servers FESV, the load per one front end server FESV increases and the processing performance of all front end servers FESV drops. However, even if the number of front end servers FESV decreases, the performance of the front end servers FESV does not make a bottle neck. Therefore, the power consumption of the information processing system SYS1 is reduced without reduction of the processing performance of the information processing system SYS1.

By setting one of the front end servers FESV to a sleep server SLPSV in response to decrease of the load to the front end servers FESV, the power consumption of the information processing system SYS1 is reduced without reduction of the processing performance of the information processing system SYS1.

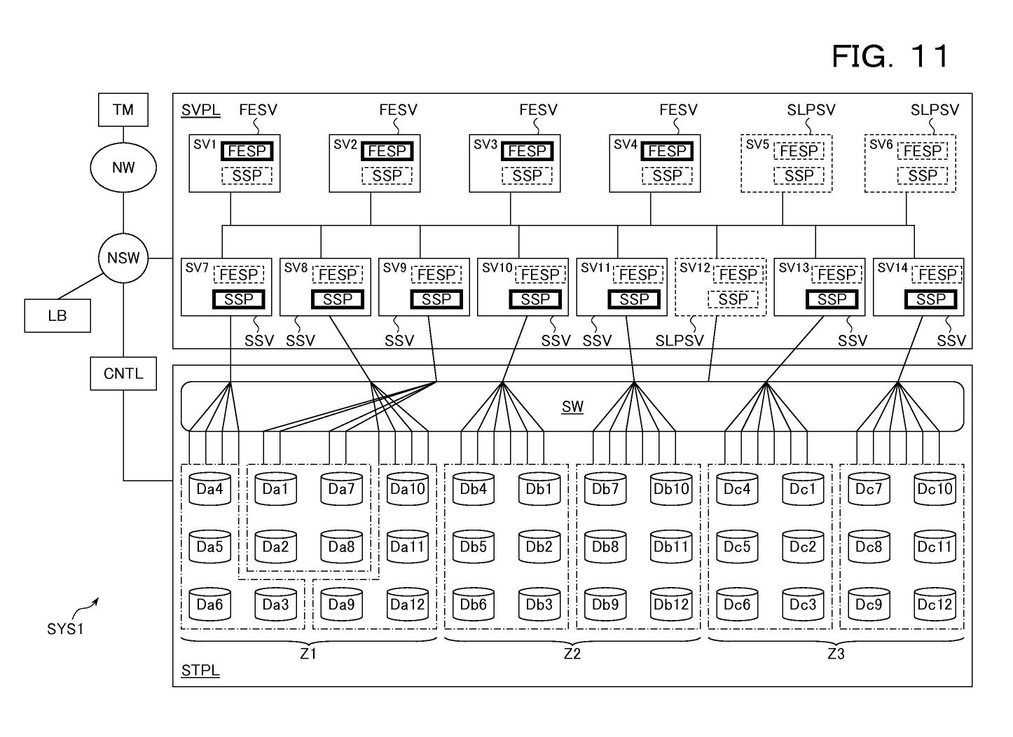

FIG. 11 is a block diagram depicting an example of a state when the load to the storage servers SSV increases in the information processing system SYS1 depicted in FIG. 3. The load to the storage servers SSV varies depending upon the number of disk apparatus D coupled with the storage servers SSV, the frequency in which data is inputted to and outputted from the disk apparatus D and the data size. The load to the storage servers SSV increases as the number of disk apparatus D coupled with the storage servers SSV increases and decreases as the number of disk apparatus D coupled with the storage servers SSV decreases. Further, the load to the storage servers SSV increases as the frequency in which data is inputted to and outputted from the disk apparatus D increases and decreases as the frequency in which data is inputted to and outputted from the disk apparatus D decreases. When the load to the storage servers SSV increases, the access performance of the disk apparatus D by the storage servers SSV makes a bottle neck. On the other hand, when the load to the storage servers SSV decreases, the access performance of the disk apparatus D by the storage servers SSV with respect to the power consumption decreases.

The collection unit GATH of the control apparatus CNTL depicted in FIG. 4 measures the load to the storage servers SSV (SV7, SV8, SV10, SV11, SV13 and SV14) in a given cycle. The collection unit GATH decides that a storage server SSV to which the load exceeding a given threshold value VTHs is applied is in a high load state in which there is no room on the performance of the storage server SSV. For example, the collection unit GATH determines the load on the basis of the utilization rate of the CPU of the storage server SSV and decides that the storage server SSV is in a high load state when the utilization rate of the CPU exceeds 85% (VTHs).

If the collection unit GATH decides a high load state, then the changing unit CHNG of the control apparatus CNTL depicted in FIG. 4 selects one of the sleep servers SLPSV (SV9) and causes the selected sleep server SLPSV to execute the storage service program SSP thereby to increase the number of storage servers SSV. The storage server SSV (SV9) is added corresponding to the zone Z1 including the storage server SSV decided to be in a high load state. Then, the changing unit CHNG sets all of the disk apparatus Da in the zone Z1 to a lock state.

Then, the changing unit CHNG executes a division process of reassigning the disk apparatus Da coupled with the storage servers SSV (SV7 and SV8) in the zone Z1 to the newly added storage server SSV (SV9). For example, the changing unit CHNG reassigns the disk apparatus Da1 and Da2 coupled with the storage server SSV (SV7) to a different storage server SSV (SV9). Further, the changing unit CHNG reassigns the disk apparatus Da7 and Da8 coupled with the storage server SSV (SV6) to a different storage server SSV (SV9). Consequently, the numbers of disk apparatus D coupled with the storage servers SSV are uniformed and the processing performance deviation of the storage servers SSV is minimized. As a result, deterioration of the processing performance of the information processing system SYS1 is reduced. After the reassigning process of the disk apparatus Da is completed, the changing unit CHNG cancels the lock state of all disk apparatus Da in the zone Z1. Then, the information processing system SYS1 is set to a state illustrated in FIG. 11.

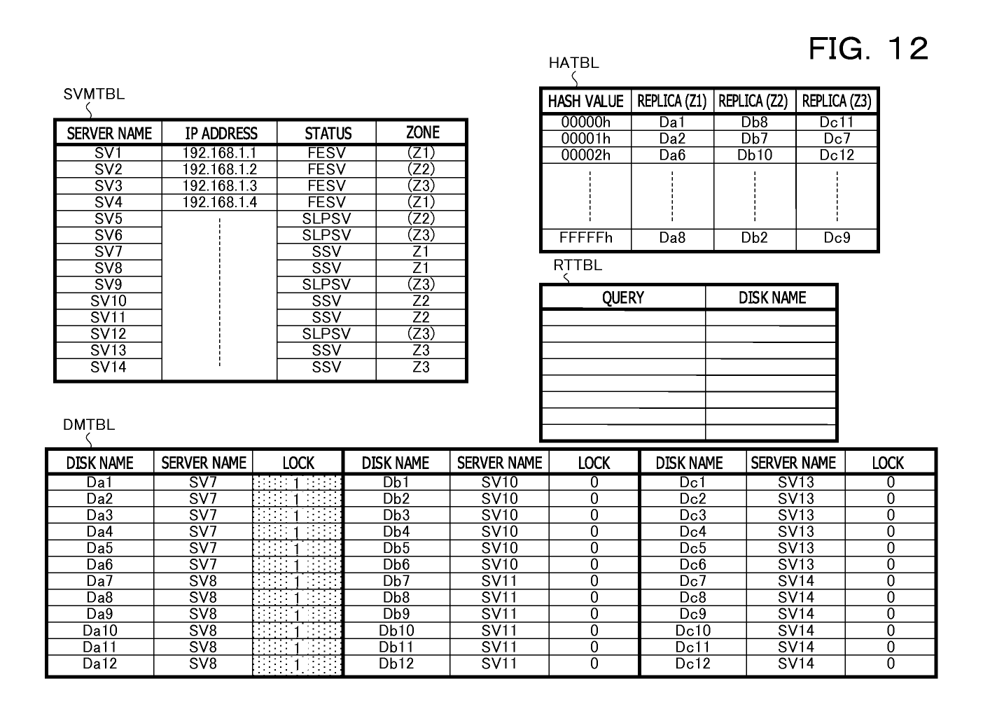

FIG. 12 is a view depicting an example of a change of the server management table SVMTBL, the disk management table DMTBL, the hash table HATBL and the retry table RTTBL when the state depicted in FIG. 3 changes to the state depicted in FIG. 11. Each site at which the state is different from the state in FIG. 6 is indicated by shading. It is to be noted that the retry table RTTBL is included in the front end servers FESV but is not included in the control apparatus CNTL and the storage servers SSV.

FIG. 12 illustrates a state in which the changing unit CHNG of the control apparatus CNTL depicted in FIG. 4 changes the disk management table DMTBL to lock the disk apparatus Da in the zone Z1. It is to be noted that the changing unit CHNG selects one of the sleep server SLPSV and turns on the power to the selected sleep server SLPSV.

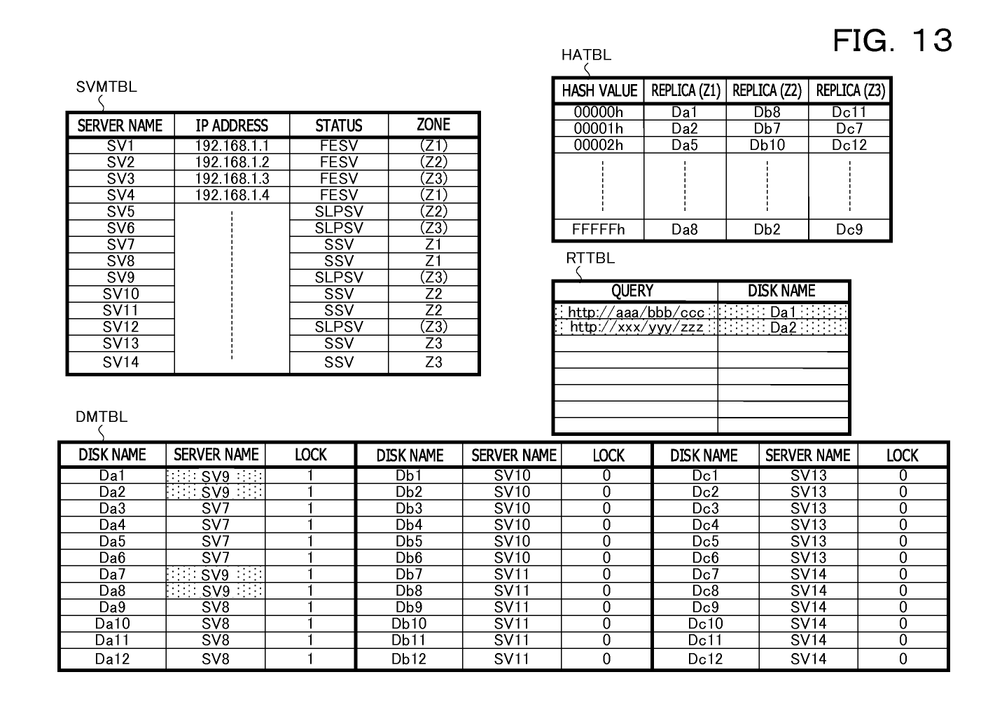

The changing unit CHNG transfers the changed disk management table DMTBL to all front end servers FESV so as to update the disk management table DMTBL. Each front end server FESV suspends writing of data into the disk apparatus Da in the zone Z1 on the basis of the updated disk management table DMTBL. Information corresponding to a writing access request with regard to which writing of data is suspended is placed into the retry table RTTBL of the front end server FESV that receives a writing request from the load balancer LB as depicted in FIG. 13.

FIG. 13 is a view depicting an example of a change of the server management table SVMTBL, the disk management table DMTBL, the hash table HATBL and the retry table RTTBL from the state depicted in FIG. 12. Each site at which the state is different from the state in FIG. 12 is indicated by shading.

If a writing access request for writing data is generated to a disk apparatus Da that is in a locked state, then the front end server FESV places information representative of a path for data (query) and information representative of a disk apparatus D into which data is to be written into the retry table RTTBL. FIG. 13 illustrates a state in which a writing access request is generated to the disk apparatus Da1 and Da2 that are in a locked state. It is to be noted that the retry table RTTBL is included in the front end servers FESV but is not included in the control apparatus CNTL and the storage servers SSV.

The changing unit CHNG of the control apparatus CNTL depicted in FIG. 4 changes the disk management table DMTBL in order to reassign the disk apparatus Da1 and Da2 from a storage server SSV (SV7) to a storage server SSV (SV9). Further, the changing unit CHNG changes the disk management table DMTBL in order to reassign the disk apparatus Da7 and Da8 from a storage server SSV (SV8) to a storage server SSV (SV9).

The changing unit CHNG instructs the switching apparatus SW to reassign the disk apparatus Da1, Da2, Da7 and Da8 on the basis of the changed disk management table DMTBL. The switching apparatus SW switches the coupling between the storage servers SSV (SV7, SV8 and SV9) and the disk apparatus Da1 to Da12 to the state illustrated in FIG. 11 in accordance with the instruction from the changing unit CHNG.

It is to be noted that the state of the server management table SVMTBL, the disk management table DMTBL and the hash table HATBL in the front end servers FESV is same as that in FIG. 12. Further, the retry table RTTBL in the front end servers FESV that do not receive a writing request into the disk apparatus Da1 and Da2 that are in a locked state remain blank similarly as in FIG. 12. The state of the server management table SVMTBL, the disk management table DMTBL and the hash table HATBL in the storage servers SSV is same as that in FIG. 6.

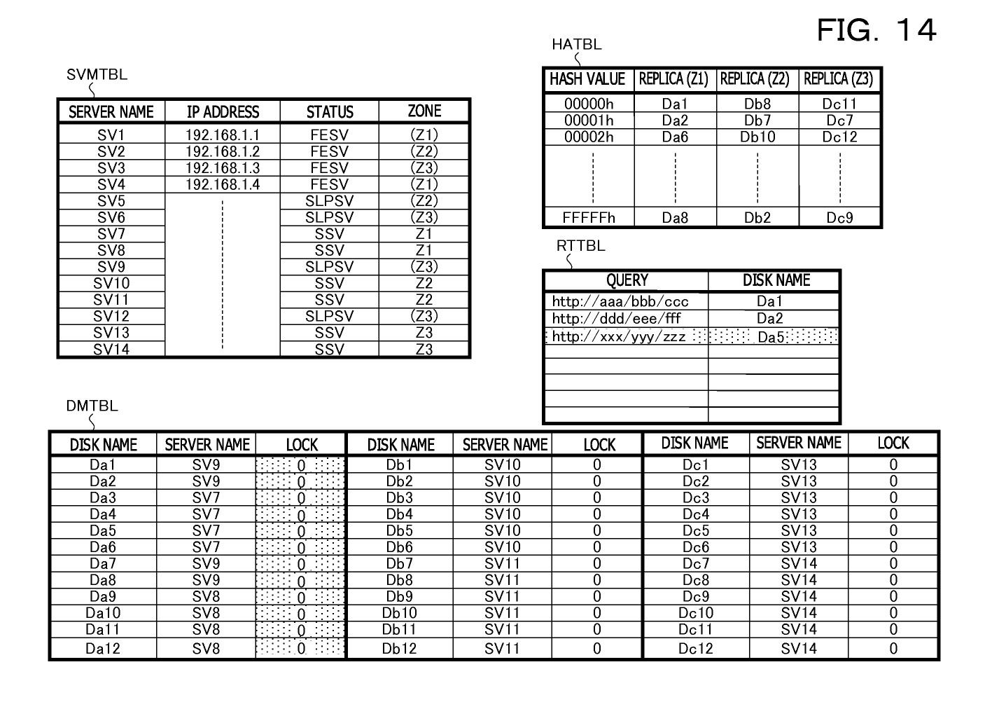

FIG. 14 is a view depicting an example of a change of the server management table SVMTBL, the disk management table DMTBL, the hash table HATBL and the retry table RTTBL from the state depicted in FIG. 13. Each site at which the state is different from the state in FIG. 13 is indicated by shading.

The changing unit CHNG of the control apparatus CNTL depicted in FIG. 4 changes the disk management table DMTBL to cancel the lock of the disk apparatus Da corresponding to the zone Z1 for which the reassignment is completed. In the example depicted in FIG. 14, before the lock of the disk management table DMTBL is canceled, a writing access request for writing data is generated in the disk apparatus Da5 that is in a locked state. Therefore, the front end server FESV receiving the writing access request places information indicative of a path for data and information indicative of the disk apparatus Da5 into which data is to be written into the retry table RTTBL.

It is to be noted that the state of the server management table SVMTBL, the disk management table DMTBL and the hash table HATBL in the front end servers FESV is same as that in FIG. 12. Meanwhile, the retry table RTTBL in the front end servers FESV that do not receive a writing request into the disk apparatus Da1, Da2 and Da5 that are in a locked state is blank similarly as in FIG. 12. The state of the server management table SVMTBL, the disk management table DMTBL and the hash table HATBL in the storage servers SSV is same as that in FIG. 6.

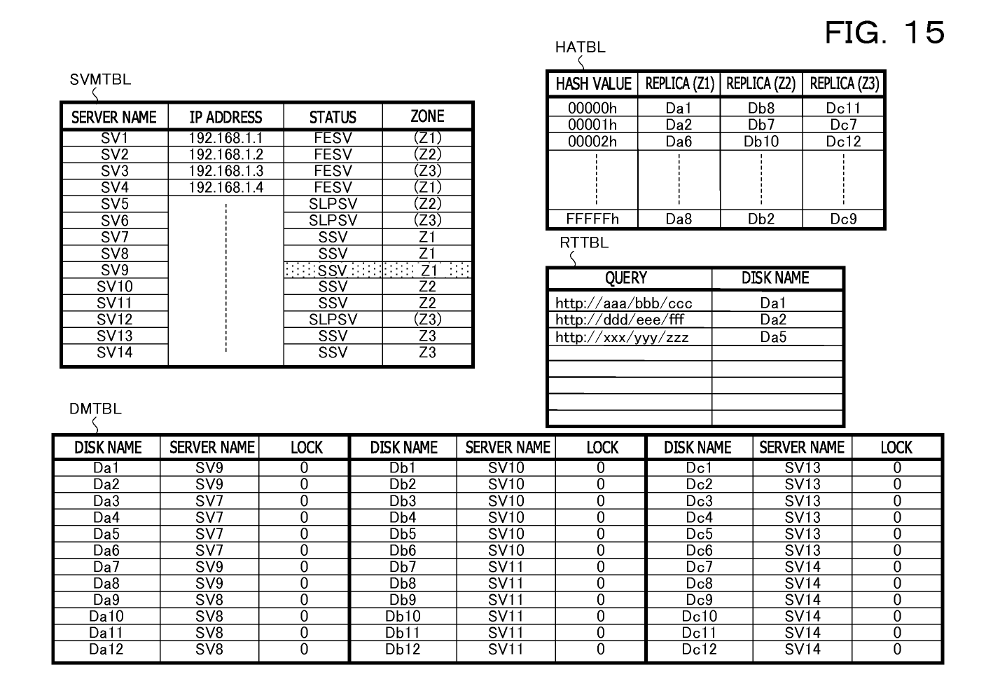

FIG. 15 is a view depicting an example of a change of the server management table SVMTBL, the disk management table DMTBL, the hash table HATBL and the retry table RTTBL from the state depicted in FIG. 14. Each site at which the state is different from the state in FIG. 14 is indicated by shading.

The changing unit CHNG of the control apparatus CNTL depicted in FIG. 4 changes the server management table SVMTBL to set the server SV9 as a storage server SSV coupled with the disk apparatus Da in the zone Z1. The changing unit CHNG instructs the server SV9, to which the power supply is turned on, to start up the storage service program SSP so that the server SV9 operates as a storage server SSV.

Then, the changing unit CHNG transfers the server management table SVMTBL, the disk management table DMTBL and the hash table HATBL illustrated in FIG. 15 to all of the front end servers FESV and all of the storage servers SSV. In other words, the server management table SVMTBL, the disk management table DMTBL and the hash table HATBL in all of the front end servers FESV and all of the storage servers SSV are set to the state illustrated in FIG. 15.

After the lock of all of the disk apparatus Da1 to Da12 allocated to the zone Z1 is canceled, the front end servers FESV execute a flash process on the basis of a transfer request from the control apparatus CNTL. The flash process is a process of writing data, whose writing is suspended, into the disk apparatus Da on the basis of the information placed in the retry table RTTBL and deleting the information placed in the retry table RTTBL. By execution of the flash process, the retry table RTTBL is placed into a blank state.

In the flash process, the front end server FESV first refers to the retry table RTTBL to determine data (query) whose writing is suspended and a disk apparatus Da into which the data is to be written. Then, the front end server FESV refers to the hash table HATBL to determine disk apparatus Db (or Dc) allocated to the different zone Z2 (or Z3) in which data same as the data to be written into the disk apparatus Da (replica data) is placed.

Then, the front end server FESV refers to the disk management table DMTBL and the server management table SVMTBL to determine the IP address of the storage server SSV coupled with the disk apparatus Db (or Dc) in which the replica data is placed. Then, the front end server FESV issues a transfer request to the determined storage server SSV for transferring (copying) the data whose writing is suspended to the disk apparatus Da. The front end server FESV deletes the information corresponding to the written data from the retry table RTTBL after the transfer of the data to the disk apparatus Da is completed.

As depicted in FIGS. 11 to 15, by adding a storage server SSV, the load per one storage server SSV decreases and the processing performance by all storage servers SSV is improved. Consequently, the bottle neck in performance of the storage servers SSV disappears.

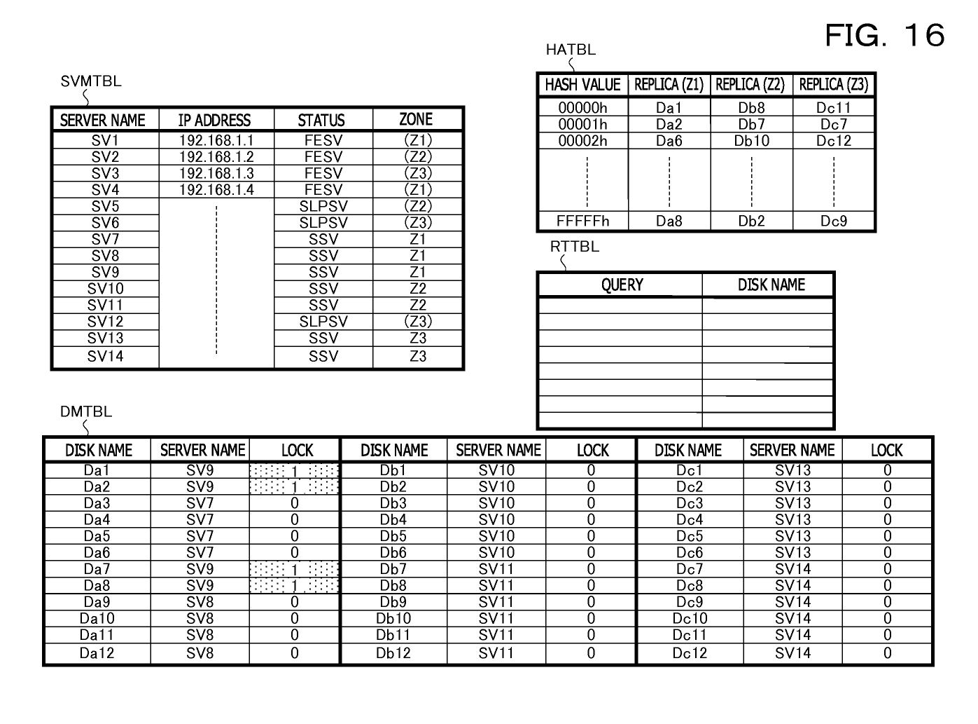

FIG. 16 is a view depicting an example of a change of the server management table SVMTBL, the disk management table DMTBL, the hash table HATBL and the retry table RTTBL when the load to the storage servers SSV decreases in the information processing system SYS1 depicted in FIG. 11. Except the retry table RTTBL, each site at which the state is different from the state in FIG. 15 is indicated by shading. It is to be noted that the retry table RTTBL is included in the front end servers FESV but is not included in the control apparatus CNTL and the storage servers SSV.

The collection unit GATH of the control apparatus CNTL depicted in FIG. 4 measures the load to each storage server SSV (SV7, SV8, SV9, SV10, SV11, SV13 and SV14) in a given cycle. The collection unit GATH decides that a storage server SSV to which the load becomes lower than a threshold value VTLs that is lower than the threshold value VTHs is in the low load state in which there is a sufficient room on the processing capability. For example, the collection unit GATH decides a load to a storage server SSV on the basis of the utilization rate of the CPU of the storage server SSV and decides a low load state when the utilization rate of the CPU is equal to or lower than 30% (VTLs). The low load state of the storage servers SSV is a state in which the performance of the storage servers SSV does not make a bottle neck even if the number of storage servers SSV is decreased by one.

In the example depicted in FIG. 16, the collection unit GATH decides that the storage server SSV (SV9) is in a low load state. The changing unit CHNG of the control apparatus CNTL depicted in FIG. 4 changes the disk management table DMTBL to set the disk apparatus Da1, Da2, Da7 and Da8 coupled with the storage server SSV (SV9) decided as being in a low load state to a lock state. The changing unit CHNG transfers the changed disk management table DMTBL to all of the front end servers FESV so as to update the disk management table DMTBL.

It is to be noted that the state of the server management table SVMTBL and the hash table HATBL in the front end servers FESV is same as that in FIG. 12. The state of the server management table SVMTBL, the disk management table DMTBL and the hash table HATBL in the storage servers SSV is same as that in FIG. 15.

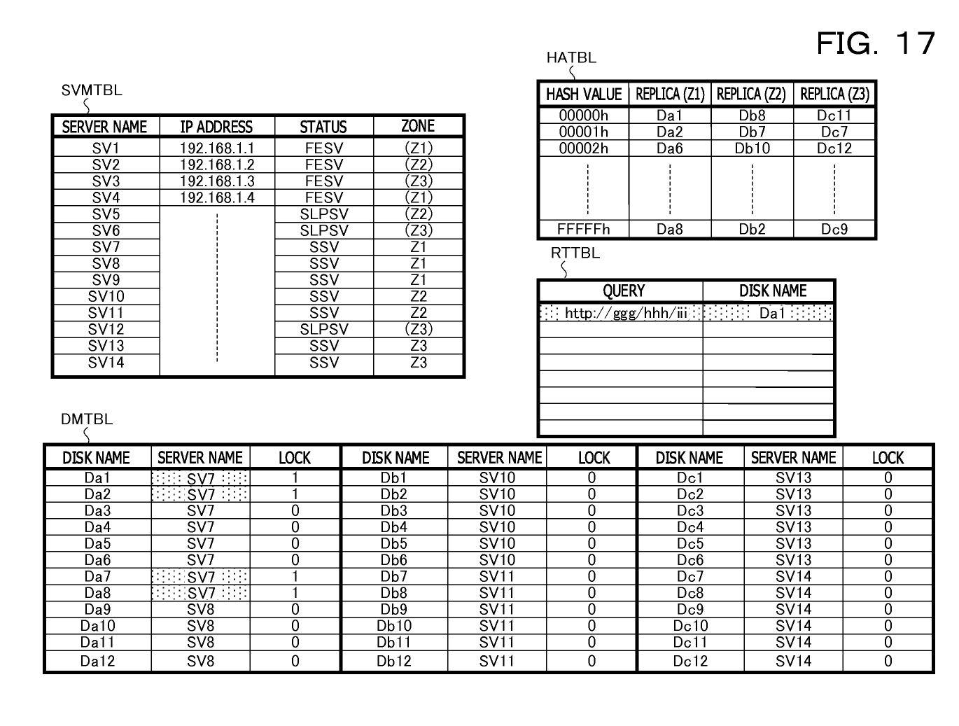

FIG. 17 is a view depicting an example of a change of the server management table SVMTBL, the disk management table DMTBL, the hash table HATBL and the retry table RTTBL from the state depicted in FIG. 16. Each site at which the state is different from the state in FIG. 16 is indicated by shading.

The changing unit CHNG of the control apparatus CNTL depicted in FIG. 4 changes the disk management table DMTBL in order to reassign the disk apparatus Da1 and Da2 from the storage server SSV (SV9) to the storage server SSV (SV7). Further, the changing unit CHNG changes the disk management table DMTBL in order to reassign the disk apparatus Da7 and Da8 from the storage server SSV (SV9) to the storage server SSV (SV8). The changing unit CHNG transfers the changed disk management table DMTBL to all of the front end servers FESV.

The changing unit CHNG instructs the switching apparatus SW to reassign the disk apparatus Da1, Da2, Da7 and Da8 on the basis of the changed disk management table DMTBL. The switching apparatus SW switches the coupling between the storage servers SSV (SV7, SV8 and SV9) and the disk apparatus Da1 to Da12 to the state illustrated in FIG. 3 on the basis of an instruction from the changing unit CHNG.

Further, while the disk management table DMTBL is updated, a writing access request for writing data is generated in the disk apparatus Da1 that is in a locked state. Therefore, the front end server FESV that receives the writing access request places information representative of a path for the data and the disk apparatus Da1 into which the data is to be written into the retry table RTTBL.

It is to be noted that the state of the server management table SVMTBL and the hash table HATBL in the front end servers FESV is same as that in FIG. 17. Meanwhile, the retry table RTTBL in the front end servers FESV that does not receive the writing request into the disk apparatus Da1 in a locked state is blank. The state of the server management table SVMTBL, the disk management table DMTBL and the hash table HATBL in the storage servers SSV is same as that in FIG. 15.

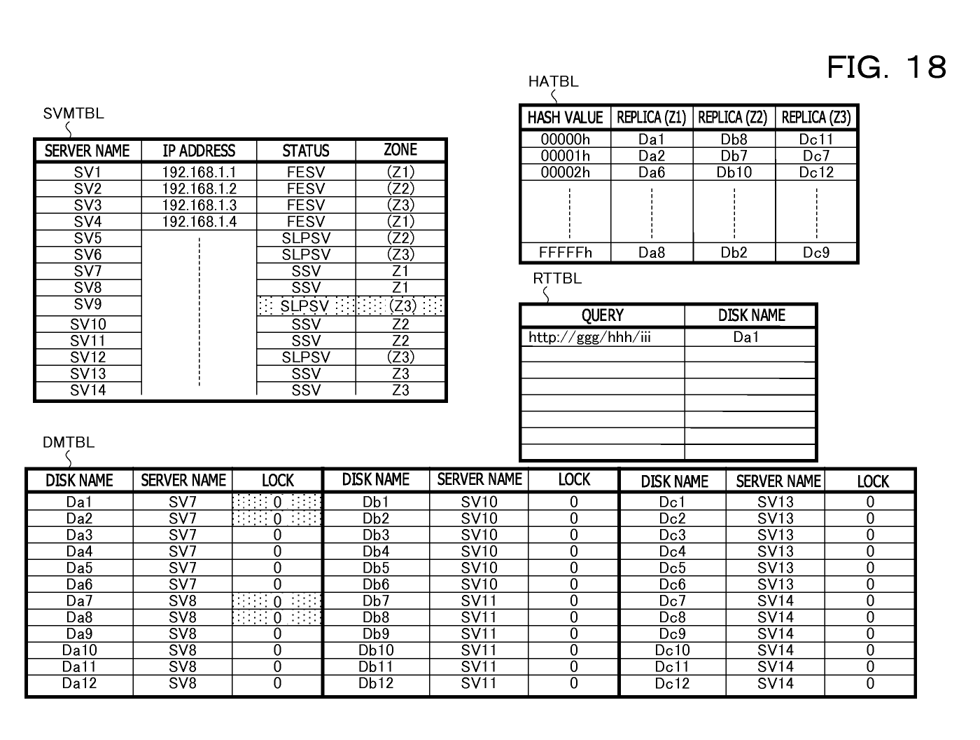

FIG. 18 is a view depicting an example of a change of the server management table SVMTBL, the disk management table DMTBL, the hash table HATBL and the retry table RTTBL from the state depicted in FIG. 17. Each site at which the state is different from the state in FIG. 17 is indicated by shading.

The changing unit CHNG of the control apparatus CNTL depicted in FIG. 4 cancels the lock of the disk apparatus Da1, Da2, Da7 and Da8 coupled with the storage servers SSV (SV7 and SV8). The changing unit CHNG changes the server management table SVMTBL to set the server SV9 from a storage server SSV to a sleep server SLPSV.

Then, the changing unit CHNG transfers the server management table SVMTBL, the disk management table DMTBL and the hash table HATBL depicted in FIG. 18 to all of the front end servers FESV and the storage servers SSV. In other words, the server management table SVMTBL, the disk management table DMTBL and the hash table HATBL in all of the front end servers FESV and all of the storage servers SSV are set to the state illustrated in FIG. 18.

After the lock of all of the disk apparatus Da1, Da2, Da7 and Da8 allocated to the zone Z1 is canceled, the front end server FESV writes data into the disk apparatus Da1 on the basis of the information placed in the retry table RTTBL. The data to be written into the disk apparatus Da1 is read out from the disk apparatus Db (or Dc) allocated to the different zone Z2 (or Z3) by referring to the hash table HATBL, the disk management table DMTBL and the server management table SVMTBL. Then, the front end server FESV deletes the information corresponding to the data written in the disk apparatus Da from the retry table RTTBL. In other words, a flash process of the retry table RTTBL is executed. By the execution of the flash process, the retry table RTTBL is placed into a blank state. Thereafter, the changing unit CHNG instructs the server SV9 to block the power supply. Consequently, the server SV9 is switched from a storage server SSV to a sleep server SLPSV. In other words, the selection of the storage server SSV (SV9) is released.

On the basis of the fact that the load to the storage servers SSV becomes lower than the threshold value VTLs, the control apparatus CNTL switches the storage server SSV (SV9) to a sleep server SLPSV. Consequently, the load per one storage server SSV increases, and the processing performance by all storage servers SSV drops. However, the processing performance of the storage servers SSV has a room on the load and does not make a bottle neck. Therefore, the power consumption of the information processing system SYS1 is reduced without degrading the processing performance of the information processing system SYS1.

FIG. 19 is a flow chart illustrating an example of operation of the control apparatus CNTL depicted in FIG. 3. The flow illustrated in FIG. 19 represents an example of a control method of the information processing system SYS1 and a control program for the control apparatus CNTL. The process illustrated in FIG. 19 is executed in a given cycle.

First at step S100, the control apparatus CNTL measures the load to the front end servers FESV by the collection unit GATH depicted in FIG. 4. For example, each of the front end servers FESV measures the load using a system admin reporter (SAR) command or the like command on the basis of an instruction from the control apparatus CNTL and notifies the control apparatus CNTL of the measured load.

Then at step S102, the control apparatus CNTL decides whether or not the loads to some of the front end servers FESV is higher than the threshold value VTHf (for example, 85%). If the loads to the front end servers FESV is higher than the threshold value VTHf, then the control apparatus CNTL advances the processing to step S200. However, if the load to all of the front end server FESV is equal to or lower than the threshold value VTHf, then the control apparatus CNTL advances the processing to step S104. It is to be noted that, since the dispersion of the load to the front end servers FESV is suppressed by the load balancer LB, the control apparatus CNTL may measure the load to one of the front end servers FESV.

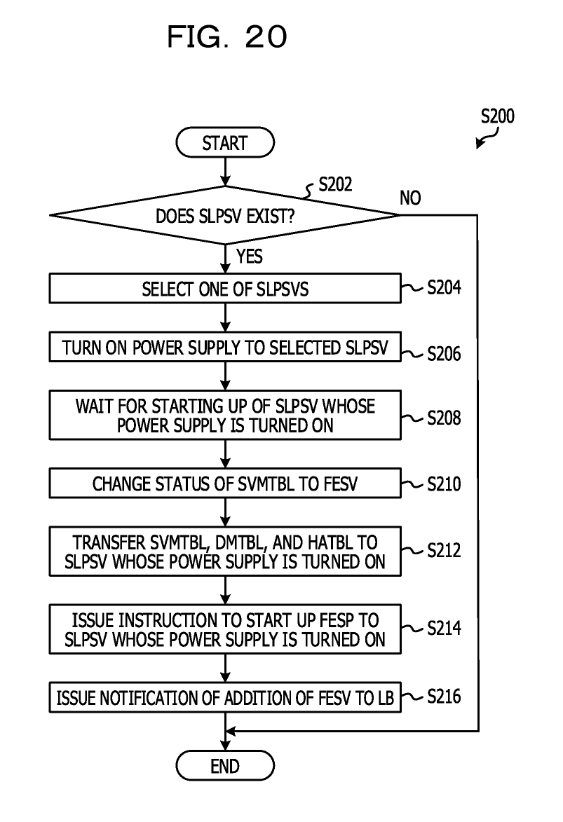

At step S200, the control apparatus CNTL executes, by the changing unit CHNG depicted in FIG. 4, an addition process of adding a front end server FESV, and then advances the processing to step S104. An example of the addition process is illustrated in FIG. 20.

At step S104, the control apparatus CNTL decides whether or not the load to some of the front end servers FESV is lower than the threshold value VTLf (for example, 30%). If the load to some of the front end servers FESV is lower than the threshold value VTLf, then the control apparatus CNTL advances the processing to step S250. However, if the load to all of the front end servers FESV is equal to or higher than the threshold value VTLf, then the control apparatus CNTL advances the processing to step S106.

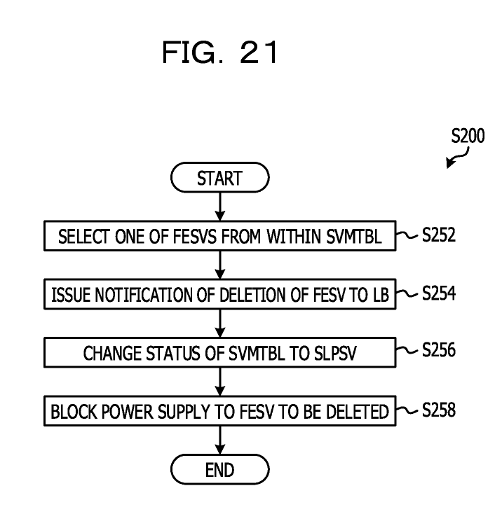

At step S250, the control apparatus CNTL executes, by the changing unit CHNG depicted in FIG. 4, a deletion process for deleting a front end server FESV. Then, the control apparatus CNTL advances the processing to step S106. An example of the deletion process is illustrated in FIG. 21.

At step S106, the control apparatus CNTL issues an enquiry to each of the front end servers FESV about whether or not the retry table RTTBL is in a blank state. If the retry table RTTBL in all of the front end servers FESV is in a blank state, then the control apparatus CNTL advances the processing to step S108. However, if information corresponding to a writing access request with regard to which writing of data is suspended is placed in the retry table RTTBL in at least one of the front end servers FESV, then the control apparatus CNTL ends the processing. By the decision at step S106, processes at steps beginning with step S108 are suppressed from being executed before the flash process is executed. Consequently, such a situation that execution of the flash process and execution of an addition/deletion process of a storage server SSV compete with each other and cause malfunction of the information processing system SYS1 is suppressed.

At step S108, the control apparatus CNTL sets the value of a variable n to “1.” Then at step S110, the control apparatus CNTL measures, by the collection unit GATH, the load to the storage servers SSV corresponding to a zone Zn (n is the variable). For example, each of the storage servers SSV measures the load using a SAR command on the basis of an instruction from the control apparatus CNTL and notifies the control apparatus CNTL of the measured load.

Then at step S112, the control apparatus CNTL decides whether or not the load to some storage server SSV is higher than the threshold value VTHs (for example, 85%). If the load to some storage server SSV is higher than the threshold value VTHs, then the control apparatus CNTL advances the processing to step S300. On the other hand, if the load to all of the storage servers SSV is equal to or lower than the threshold value VTHs, then the control apparatus CNTL advances the processing to step S114.

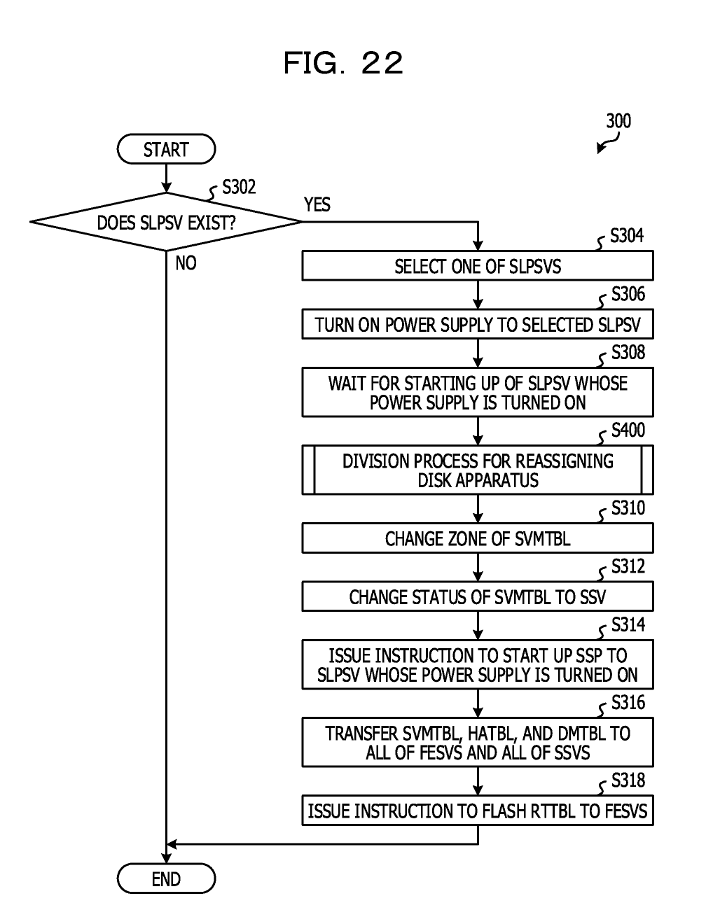

At step S300, the control apparatus CNTL executes, by the changing unit CHNG depicted in FIG. 4, an addition process of adding a storage server SSV. Then, the control apparatus CNTL advances the processing to step S114. An example of the addition process is illustrated in FIG. 22.

At step S114, the control apparatus CNTL decides whether or not the load to some storage server SSV is lower than the threshold value VTLs (for example, 30%). If the load to some storage server SSV is lower than the threshold value VTLs, then the control apparatus CNTL advances the processing to step S350. However, if the load to all of the storage servers SSV is equal to or higher than the threshold value VTLs, then the control apparatus CNTL advances the processing to step S116. It is to be noted that, when the loads to all of the storage servers SSV are lower than the threshold value VTLs, then the control apparatus CNTL may advance the processing to step S350 whereas, when the load to some of the storage servers SSV is equal to or higher than the threshold value VTLs, the control apparatus CNTL advances the processing to step S116.

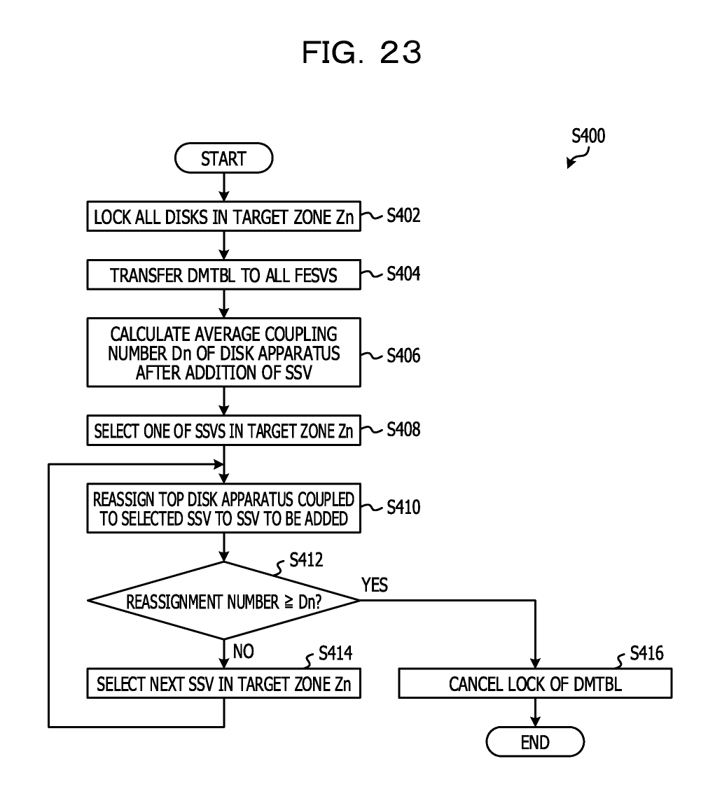

At step S350, the control apparatus CNTL executes, by the changing unit CHNG, a deletion process of deleting a storage server SSV. Then, the control apparatus CNTL advances the processing to step S116. An example of the deletion process is illustrated in FIG. 23.

At step S116, the control apparatus CNTL increments the variable n by “1.” Then, at step S118, the control apparatus CNTL decides whether or not the zone Zn exists. If the zone Zn exists, then the control apparatus CNTL returns the processing to step S110. On the other hand, if the zone Zn does not exist, namely, if the load to the storage servers SSV corresponding to all zones Z1 to Z3 is measured, then the control apparatus CNTL ends the processing.

FIG. 20 is a flow chart illustrating an example of the process (addition process of a front end server FESV) at step S200 depicted in FIG. 19. Though not restricted, the process illustrated in FIG. 20 is executed by the changing unit CHNG of the control apparatus CNTL.

First at step S202, the control apparatus CNTL decides whether or not a sleep server SLPSV exists in the server pool SVPL. If a sleep server SLPSV exists in the server pool SVPL, then the control apparatus CNTL advances the processing to step S204. On the other hand, if a sleep server SLPSV does not exist in the server pool SVPL, then the control apparatus CNTL ends the processing because addition of a front end server FESV is difficult.

At step S204, the control apparatus CNTL selects one of the sleep servers SLPSV. Then at step S206, the control apparatus CNTL executes a command for turning on the power supply to the selected sleep server SLPSV so that the power supply to the sleep server SLPSV is turns on. For example, each server SV includes a controller BMC (base management controller) for the management of the system. Then, the control apparatus CNTL accesses the controller BMC by a protocol such as intelligent platform management interface (IPMI) to control the state of the power supply to each server SV. It is to be noted that the process at step S206 may be executed alternatively by the controller SLPC of the control apparatus CNTL.

Then at step S208, the control apparatus CNTL waits for startup of the sleep server SLPSV to which the power supply is turned on. Then at step S210, the control apparatus CNTL changes the status of the sleep server SLPSV to which the power supply is turned on to “FESV” in the server management table SVMTBL. Then at step S212, the control apparatus CNTL transfers the server management table SVMTBL, the disk management table DMTBL and the hash table HATBL to the sleep server SLPSV to which the power supply is turned on. For example, the control apparatus CNTL uses a secure copy (SCP) command or the like to copy the server management table SVMTBL, the disk management table DMTBL and the hash table HATBL from the memory MEM of the control apparatus CNTL into the memory MEM of the sleep server SLPSV.

Then at step S214, the control apparatus CNTL instructs the sleep server SLPSV, to which the power supply is turned on, to start up the front end service program FESP. Then at step S216, the control apparatus CNTL notifies the load balancer LB of the information indicative of the addition of the front end server FESV and then ends the processing.

FIG. 21 is a flow chart illustrating an example of the process at step S250 (deletion process of a front end server FESV) depicted in FIG. 19. Though not restricted, the process illustrated in FIG. 21 is executed by the changing unit CHNG and the controller SLPC of the control apparatus CNTL.

First at step S252, the changing unit CHNG of the control apparatus CNTL selects one of entries in which the status is set to “FESV” from within the server management table SVMTBL. Then at step S254, the changing unit CHNG of the control apparatus CNTL notifies the load balancer LB of deletion of a front end server FESV corresponding to the entry selected at step S252. In particular, the control apparatus CNTL notifies the load balancer LB of an instruction to delete the front end server FESV corresponding to the entry selected at step S252 from the dispersion destination of the load.

Then at step S256, the changing unit CHNG of the control apparatus CNTL changes the status of the entry selected at step S252 to “SLPSV” in the server management table SVMTBL. Then at step S258, the controller SLPC of the control apparatus CNTL blocks the power supply to the front end server FESV corresponding to the entry selected at step S252 thereby to decrease the number of front end servers FESV. For example, the controller SLPC of the control apparatus CNTL accesses the controller BMC of the front end server FESV by a protocol such as IPMI to block the power supply to the front end server FESV.

FIG. 22 is a flow chart illustrating an example of the process at step S300 (addition process of a storage server SSV) depicted in FIG. 19. Though not restricted, the process illustrated in FIG. 22 is executed by the changing unit CHNG of the control apparatus CNTL.

First at step S302, the control apparatus CNTL decides whether or not a sleep server SLPSV exists in the server pool SVPL. If a sleep server SLPSV exists in the server pool SVPL, then the control apparatus CNTL advances the processing to step S304. On the other hand, if a sleep server SLPSV does not exist in the server pool SVPL, then the control apparatus CNTL ends the processing because addition of a storage server SSV is difficult.

At step S304, the control apparatus CNTL selects one of the sleep servers SLPSV. Then at step S306, the control apparatus CNTL turns on the power supply to the selected sleep server SLPSV. For example, the control apparatus CNTL accesses the controller BMC of the sleep server SLPSV by a protocol such as IPMI to turn on the power supply to the sleep server SLPSV. It is to be noted that process at step S306 may be executed alternatively by the controller SLPC of the control apparatus CNTL. Then at step S308, the control apparatus CNTL waits startup of the sleep server SLPSV to which the power supply is turned on.

Then at step S400, the control apparatus CNTL executes a division process of reassigning a disk apparatus D coupled with a storage server SSV that is in operation to a storage server SSV to be newly added. An example of the division process is illustrated in FIG. 23.

Then at step S310, the control apparatus CNTL changes the region in a zone corresponding to the storage server SSV to be newly added to the information indicative of a target zone Zn in the server management table SVMTBL. Then at step S312, the control apparatus CNTL changes the status corresponding to the storage server SSV to be newly added from “SLPSV” to “SSV” in the server management table SVMTBL.

Then at step S314, the control apparatus CNTL instructs the sleep server SLPSV to which the power supply is turned on to start up the storage service program SSP. Then at step S316, the control apparatus CNTL transfers the server management table SVMTBL, the disk management table DMTBL and the hash table HATBL to all of the front end servers FESV and all of the storage servers SSV. For example, the transfer of the server management table SVMTBL, the disk management table DMTBL and the hash table HATBL is executed using an SCP command. Then at step S318, the control apparatus CNTL instructs the front end servers FESV to perform a flash process for the retry table RTTBL. Thereafter, the control apparatus CNTL ends the processing.

FIG. 23 is a flow chart illustrating an example of the process at step S400 (division process) depicted in FIG. 22. First at step S402, the control apparatus CNTL accesses the disk management table DMTBL to set all of the disk apparatus D belonging to a target zone Zn, in which a storage server SSV is to be added, to a lock state. Then at step S404, the control apparatus CNTL transfers the changed disk management table DMTBL to all of the front end servers FESV so as to update the disk management table DMTBL.

Then at step S406, the control apparatus CNTL determines an average value Dn of the number of disk apparatus D coupled per one storage server SSV after the addition of a storage server SSV. Then at step S408, the control apparatus CNTL selects one of the storage servers SSV existing in the target zone Zn. Then at step S410, the control apparatus CNTL reassigns the top disk apparatus D from among the disk apparatus D coupled with the selected storage server SSV to the storage server SSV to be added. Then, the processing advances to step S412. It is to be noted that the disk apparatus D to be reassigned may be an arbitrary disk apparatus D coupled with the selected storage server SSV.

Then at step S412, the control apparatus CNTL decides whether or not the number of reassigned disk apparatus D is equal to or greater than the average value Dn. If the number of reassigned disk apparatus D is equal to or greater than the average value Dn, then the control apparatus CNTL advances the processing to step S416. However, if the number of reassigned disk apparatus D is smaller than the average value Dn, then the control apparatus CNTL advances the processing to step S414.

At step S414, the control apparatus CNTL selects a next one of the storage servers SSV in the target zone Zn, whereafter the control apparatus CNTL returns the processing to step S410. A storage server SSV is selected cyclically until the number of reassigned disk apparatus D becomes equal to or greater than the average value Dn. On the other hand, if the number of reassigned disk apparatus D is equal to or greater than the average value Dn at step S412, then the control apparatus CNTL accesses the disk management table DMTBL to cancel the locked state of the disk management table DMTBL at step S416. Thereafter, the control apparatus CNTL ends the processing.

When the information processing system SYS1 depicted in FIG. 3 adds a storage server SSV to the zone Z1 to set the state illustrated in FIG. 11, the average value Dn of the disk apparatus D to be reassigned is “4.0” (the total number “12” of the disk apparatus D in the zone Z1/the total number “3” of storage servers SSV after addition). For example, if one storage server SSV is added to the zone D in which 21 disk apparatus D are coupled with three storage servers SSV, the average value Dn is “5.25” (21/4). In this case, reassignment of a disk apparatus D is repeated until six disk apparatus D are coupled with the storage server SSV to be added.

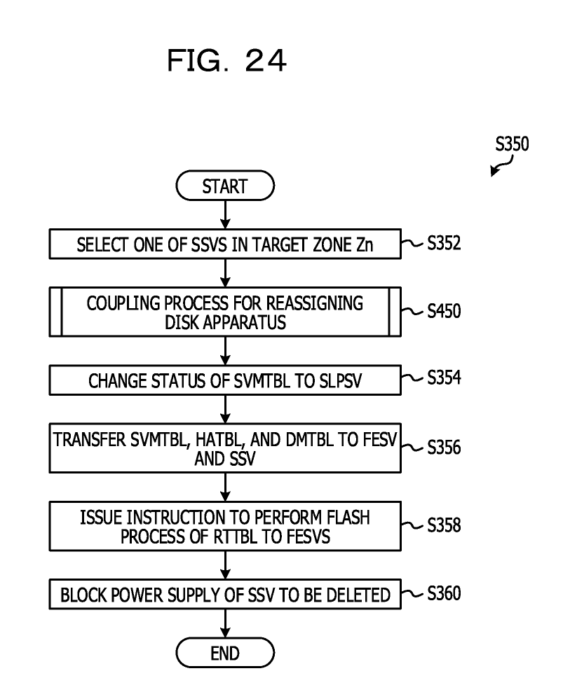

FIG. 24 is a flow chart illustrating an example of the process at step S350 (deletion process of a storage server SSV) depicted in FIG. 19. Though not restricted, the process illustrated in FIG. 21 is executed by the changing unit CHNG and the controller SLPC of the control apparatus CNTL.

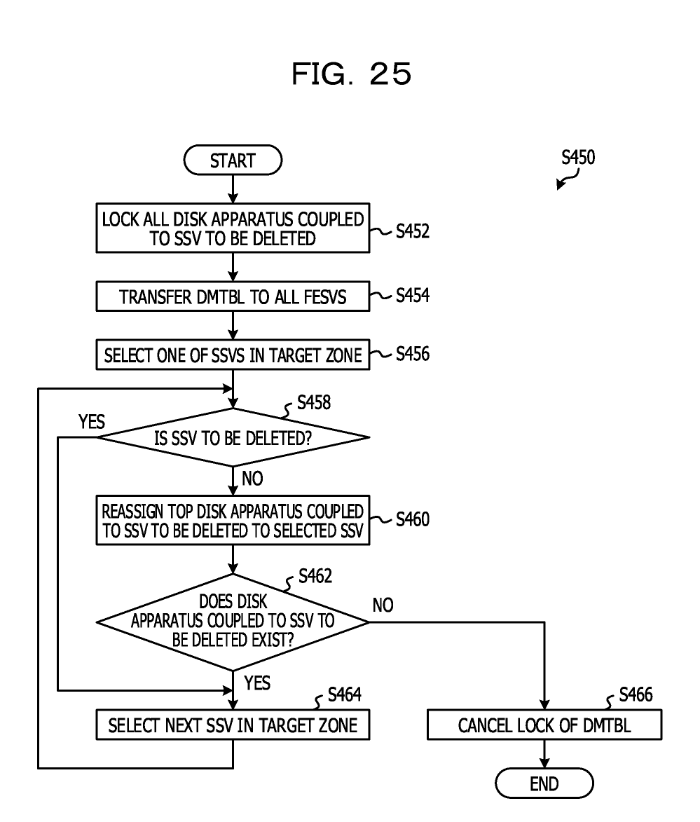

First at step S352, the changing unit CHNG of the control apparatus CNTL selects one of the storage servers SSV that belong to the target zone Zn as a storage server SSV to be deleted. Then at step S450, the changing unit CHNG of the control apparatus CNTL executes a coupling process of reassigning a disk apparatus D from a storage server SSV whose operation is to be stopped to a storage servers SSV which is to continue operation. An example of the coupling process is illustrated in FIG. 25.

Then at step S354, the changing unit CHNG of the control apparatus CNTL changes the status of the storage server SSV to be deleted to “SLPSV” in the server management table SVMTBL. Then at step S356, the changing unit CHNG of the control apparatus CNTL transfers the server management table SVMTBL, the disk management table DMTBL and the hash table HATBL to all of the front end servers FESV and all of the storage servers SSV. The transfer of the server management table SVMTBL, the disk management table DMTBL and the hash table HATBL is executed using a SCP command or the like.

Then at step S358, the changing unit CHNG of the control apparatus CNTL instructs the front end servers FESV to execute a flash process of the retry table RTTBL. Then at step S360, the controller SLPC of the control apparatus CNTL blocks the power supply to the storage server SSV to be deleted. Thereafter, the controller SLPC ends the processing. For example, the controller SLPC accesses the controller BMC of the storage server SSV by a protocol such as IPMI to block the power supply to the storage server SSV.

FIG. 25 is a flow chart illustrating an example of the process at step S450 (coupling process) depicted in FIG. 24. First at step S452, the control apparatus CNTL accesses the disk management table DMTBL to set all of the disk apparatus D coupled with the storage server SSV to be deleted to a locked state. Then at step S454, the control apparatus CNTL transfers the changed disk management table DMTBL to all of the front end servers FESV to update the disk management table DMTBL. The transfer of the disk management table DMTBL is executed using an SCP command or the like.

Then at step S456, the control apparatus CNTL selects one of the storage servers SSV existing in the target zone Zn to which the storage server SSV to be deleted belongs. Then at S458, the control apparatus CNTL decides whether or not the selected storage server SSV is the storage server SSV to be deleted. If the selected storage server SSV is the storage server SSV to be deleted, then the control apparatus CNTL advances the processing to step S464. On the other hand, if the selected storage server SSV is not the storage server SSV to be deleted, then the control apparatus CNTL advances the processing to step S460.

At step S460, the control apparatus CNTL reassigns the top disk apparatus D from among the disk apparatus D coupled with the storage server SSV to be deleted to the selected storage server SSV. Then, the control apparatus CNTL advances the processing to step S462. It is to be noted that the disk apparatus D to be reassigned may be an arbitrary one of the disk apparatus D coupled with the storage server SSV to be deleted.

Then at step S462, the control apparatus CNTL decides whether or not there remains a disk apparatus D coupled with the storage server SSV to be deleted. If there remains a disk apparatus D coupled with the storage server SSV to be deleted, then the control apparatus CNTL advances the processing to step S464. However, if no disk apparatus D is coupled with the storage server SSV to be deleted, then the control apparatus CNTL advances the processing to step S466.

At step S464, the control apparatus CNTL selects a next storage server SSV in the target zone Zn, whereafter the control apparatus CNTL returns the processing to step S458. On the other hand, if the reassignment of the disk apparatus D from the storage server SSV to be deleted is completed, then the control apparatus CNTL accesses the disk management table DMTBL to cancel the lock state of the disk management table DMTBL at step S466, thereby ending the processing.

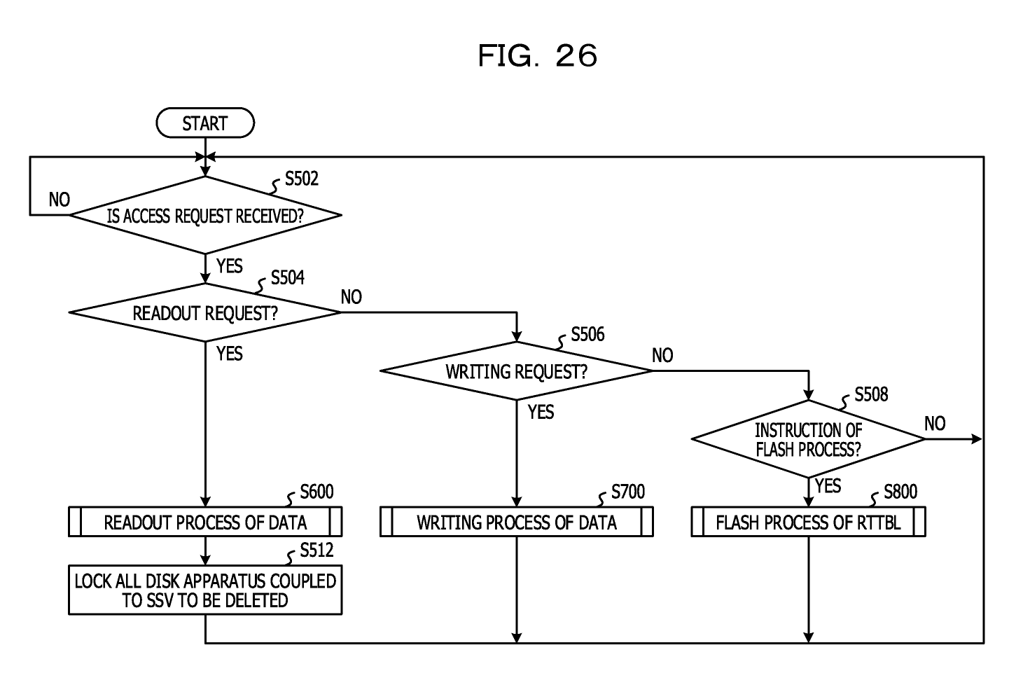

FIG. 26 is a flow chart illustrating an example of operation of the front end server FESV depicted in FIG. 3. The operation depicted in FIG. 26 is implemented by the CPU of the front end server FESV depicted in FIG. 5 executing the front end service program FESP.

First at step S502, the front end server FESV waits that the front end server FESV receives an access request supplied thereto from the terminal apparatus TM through the load balancer LB. If an access request is received, then the front end server FESV decides at step S504 whether or not the access request is a readout request. If the access request is a readout request, then the front end server FESV advances the processing to step S600, but if the access request is not a readout request, then the front end server FESV advances the processing to step S506.

At step S506, the front end server FESV decides whether or not the access request is a writing request. If the access request is a writing request, then the processing advances to step S700, but if the access request is not a writing request, then the front end server FESV advances the processing to step S508.

At step S508, the front end server FESV decides whether or not the front end server FESV receives an instruction for a flash process of the retry table RTTBL from the control apparatus CNTL. If the front end server FESV receives an instruction for a flash process of the retry table RTTBL, then the processing is advanced to step S800. If the front end server FESV does not receive an instruction for a flash process of the retry table RTTBL, then the front end server FESV returns the processing to step S502.

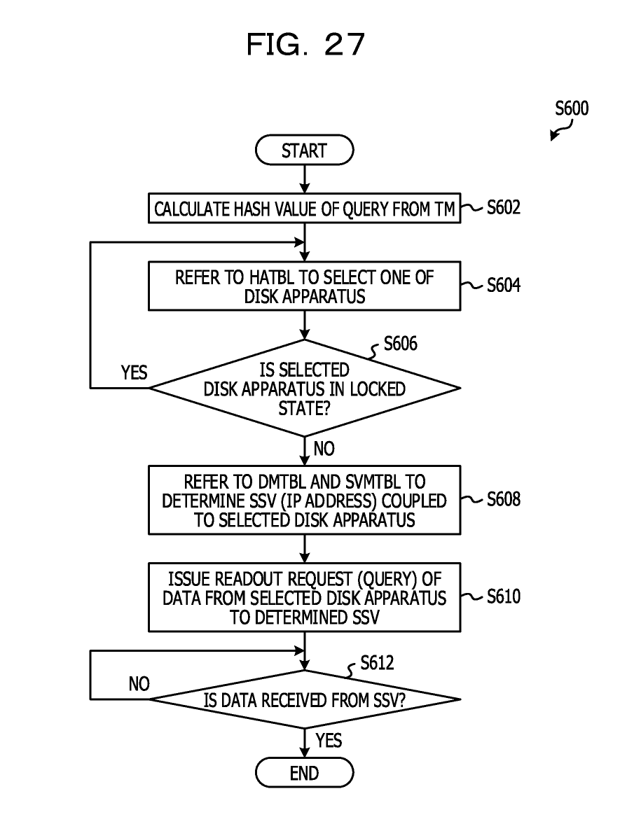

At step S600, the front end server FESV executes a readout process of data. An example of the data readout process is illustrated in FIG. 27. Then at step S512, the front end server FESV sends data read out at step S600 back to the terminal apparatus TM, whereafter the front end server FESV returns the processing to step S502.

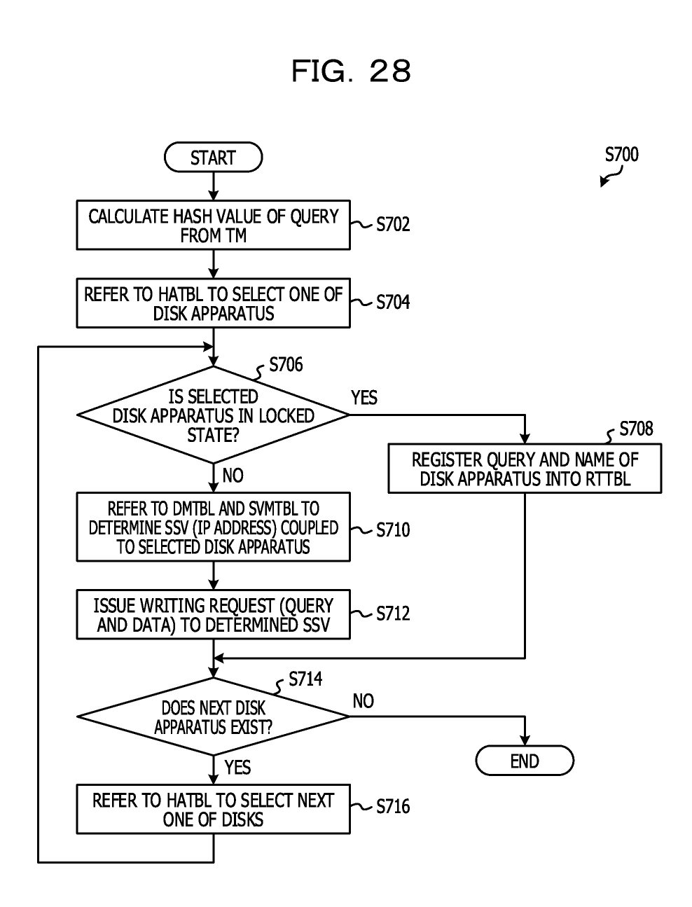

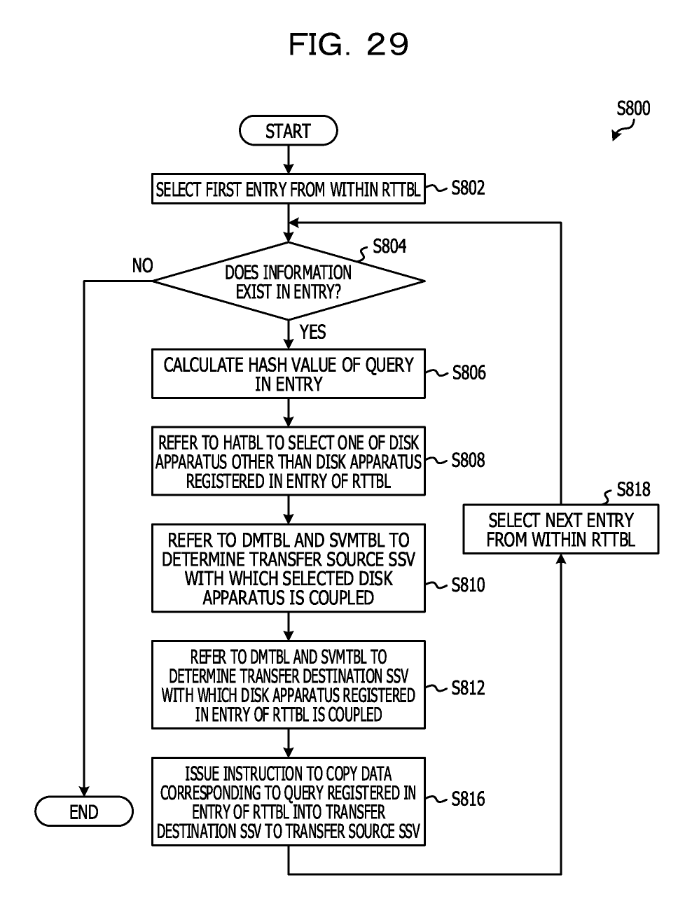

At step S700, the front end server FESV executes a data writing process, whereafter the front end server FESV returns the processing to step S502. An example of the data writing process is illustrated in FIG. 28. On the other hand, at step S800, the front end server FESV executes a flash process of the retry table RTTBL, whereafter the processing returns to step S502. An example of the flash process is illustrated in FIG. 29.

FIG. 27 is a flow chart illustrating an example of the process at step S600 (readout process) illustrated in FIG. 26. First at step S602, the front end server FESV determines a hash value by inputting a query (path or the like of data) included in the readout request received from the terminal apparatus TM to a hash function. Then at step S604, the front end server FESV refers to the hash table HATBL to select one of the disk apparatus D (Da, Db or Dc) corresponding to the hash value determined at step S602.

Then as step S606, the front end server FESV refers to the disk management table DMTBL to decide whether the selected disk apparatus D is in a locked state. If it is decided that the selected disk apparatus D is in a locked state, then the front end server FESV advances the processing to step S604 in order to select some other disk apparatus D. However, if the selected disk apparatus D is not in a locked state, then the front end server FESV advances the processing to step S608.

At step S608, the front end server FESV refers to the disk management table DMTBL to determine a storage server SSV coupled with the selected disk apparatus D. Further, the front end server FESV refers to the server management table SVMTBL to determine the IP address of the determined storage server SSV.

Then at step S610, the front end server FESV issues a readout request (query) to the storage server SSV determined at step S608 in order to read out data from the disk apparatus D selected at step S604.

Then at step S612, the front end server FESV waits that the front end server FESV receives data from the storage server SSV, thereby ending the data readout process.

FIG. 28 is a flow chart illustrating an example of the process at step S700 (writing process) depicted in FIG. 26. First at step S702, the front end server FESV determines a hash value by inputting the query (path or the like of data) included in the writing request received from the terminal apparatus TM to a hash function. Then at step S704, the front end server FESV refers to the hash table HATBL to select one of the disk apparatus D (Da, Db or Dc) corresponding to the hash value determined at step S702.

Then at step S706, the front end server FESV refers to the disk management table DMTBL to determine whether or not the selected disk apparatus D is in a locked state. If the selected disk apparatus D is in a locked state, then the front end server FESV advances the processing to step S708. However, if the selected disk apparatus D is not in a locked state, then the front end server FESV advances the processing to step S710.

At step S708, the front end server FESV registers the query included in the writing request and the information representative of the locked disk apparatus D into the retry table RTTBL. Then, the front end server FESV advances the processing to step S714.

At step S710, the front end server FESV refers to the disk management table DMTBL to determine a storage server SSV coupled with the selected disk apparatus D. Further, the front end server FESV refers to the server management table SVMTBL to determine the IP address of the determined storage server SSV.

Then at step S712, the front end server FESV issues a writing request (query and data) to the storage server SSV determined at step S710 in order to write data into the disk apparatus D selected at step S604.

Then as step S714, the front end server FESV decides whether or not there remains a disk apparatus D that has not been selected as yet among the disk apparatus D (Da, Db and Dc) corresponding to the hash values. If such a disk apparatus D remains, then the front end server FESV advances the processing to step S716. However, if all of the disk apparatus Da (Da, Db and Dc) corresponding to the hash values have been selected, then the front end server FESV ends the data writing process.

At step S716, the front end server FESV refers to the hash table HATBL to select one which has not been selected as yet from among the disk apparatus D (Da, Db and Dc) corresponding to the hash values. Thereafter, the front end server FESV returns the processing to step S706.

FIG. 29 is a flow chart illustrating an example of the process at step S800 (flash process) depicted in FIG. 26. First at step S802, the front end server FESV selects a first entry from within the retry table RTTBL. Then at step S804, the front end server FESV decides whether or not information is placed in the selected entry. If information is placed in the selected entry, then the front end server FESV advances the processing to step S806, but if information is not placed in the selected entry, then the front end server FESV ends the processing.

At step S806, the front end server FESV determines a hash value of the query placed in the selected entry. Then at step S808, the front end server FESV refers to the hash table HATBL to select one of the disk apparatus D that are different from the disk apparatus D indicated by the information placed in the site of the disk name of the selected entry. For example, if information representative of the disk apparatus Da is included in the entry, then the front end server FESV selects one of the disk apparatus Db and Dc placed in the hash table HATBL.

Then at step S810, the front end server FESV refers to the disk management table DMTBL to determine a storage server SSV coupled with the selected disk apparatus D as a storage server SSV of the transfer source of the data. Further, the front end server FESV refers to the server management table SVMTBL to determine the IP address of the determined storage server SSV. After step S810, the front end server FESV advances the processing to step S812.

At step S812, the front end server FESV refers to the disk management table DMTBL to determine a storage server SSV coupled with the disk apparatus D registered in the entry of the retry table RTTBL as a storage server SSV of the transfer destination of the data. Further, the front end server FESV refers to the server management table SVMTBL to determine the IP address of the determined storage server SSV.

Then at step S816, the front end server FESV issues, to the storage server SSV of the transfer source, an instruction to copy data corresponding to the query registered in the entry of the retry table RTTBL into the storage server SSV of the transfer destination. Then, at step S818, the front end server FESV selects a next entry from within the retry table RTTBL. Then, the front end server FESV returns the processing to step S804.

It is to be noted that, if a failure occurs with a front end server FESV that is executing a flash process of the retry table RTTBL, then there is the possibility that the information placed in the retry table RTTBL may be lost. In this case, the retry process is interrupted, and data is not written into a disk apparatus D into which data has not been written by a division process or a coupling process. In order to minimize occurrence of such a failure, it seems a possible idea to allocate the retry table RTTBL to a nonvolatile storage area of the hard disk drive HDD, an SSD or the like. This makes it possible to restart a flash process by rebooting of the system even when the front end server FESV is restarted due to occurrence of a failure.

Further, in each storage server SSV, by periodically inspecting whether a given number of replica data are stored in the disk apparatus Da, Db and Dc, the retry process itself may not be used. If replica data are retained in one of the disk apparatus Da, Db and Dc, then it is possible restore given replica data. Further, the retry process itself may not be used by rejecting a writing request from the terminal apparatus TM during a division process or a coupling process.

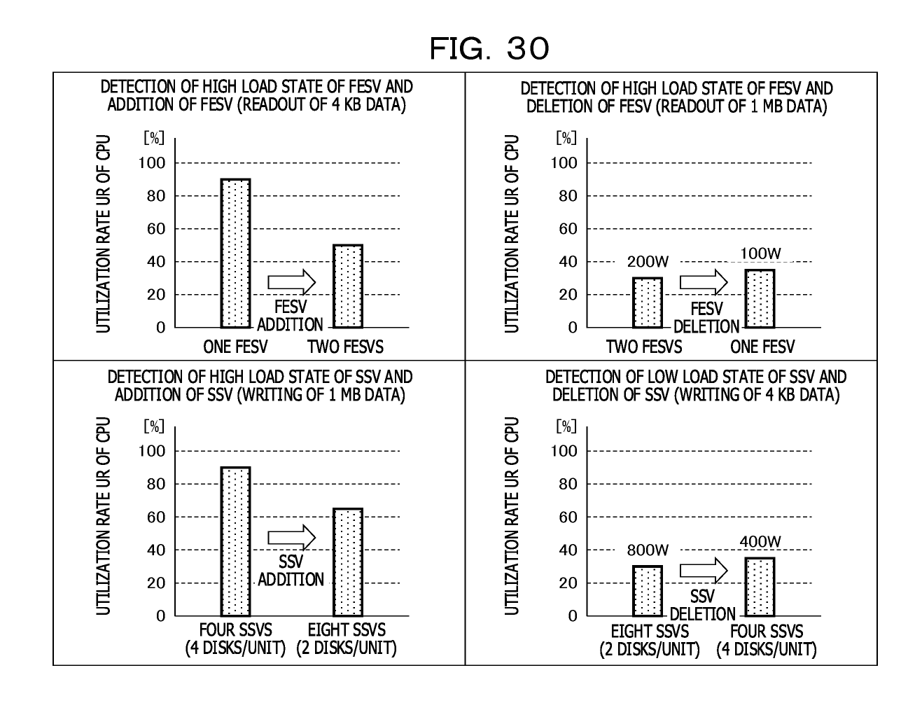

FIG. 30 is a view depicting an example of an effect when the numbers of front end servers FESV and storage servers SSV are changed in the information processing system SYS1 depicted in FIG. 3. FIG. 30 illustrates part of data obtained by a simulation. It is assumed that the power consumption of each of the front end servers FESV and the storage servers SSV is 100 W (watt).

A graph at a left upper region in FIG. 30 depicts an example in which a high load state is detected during operation of one front end server FESV that repeats a readout request of data of 4 kilobytes and one different front end server FESV is added. By adding one front end server FESV, the utilization rate UR of the CPU of each front end server FESV drops from 88% to 48% while the processing performance enhances.

A graph at a right upper region in FIG. 30 depicts an example in which a low load state is detected during operation of two front end servers FESV that repeat a readout request of data of 1 megabyte and one of the front end servers FESV is deleted. For example, if the communication rate of the network NW depicted in FIG. 3 is 1 gigabit per second (Gbps), the network NW can transmit 125 1-megabyte data for one second. If it is assumed that the processing performance per one front end server FESV is 1000 instructions per second, then the processing performance of the two front end servers FESV is considered excessive.

Even if one of the front end servers FESV is deleted, the processing performance of the front end server FESV has a room and the increasing rate of the utilization rate UR of the CPU is small. In other words, in a state in which the communication rate of the network NW makes a bottle neck, the power consumption is reduced by 100 W while the processing performance of the front end server FESV is little reduced.

A graph in a left lower region in FIG. 30 depicts an example in which a high load state is detected during operation of four storage servers SSV that repeat writing of data of 1 megabyte into a disk apparatus D and four storage servers SSV are added. By adding the storage servers SSV, the number of disk apparatus D coupled with the storage servers SSV is reduced to one half, and the utilization rate UR of the CPU of each storage server SSV drops from 91% to 62% while the processing performance enhances.

A graph in a right lower region in FIG. 30 depicts an example in which a low load state is detected during operation of eight storage servers SSV that repeat writing of data of 4 kilobytes into a disk apparatus D and four storage servers SSV are deleted. In the low load state, the writing frequency of data into a disk apparatus D by a storage server SSV is low and there is a room on the processing performance of the storage servers SSV in comparison with that in a high load state. Therefore, also where storage servers SSV are deleted, the increasing rate of the utilization rate UR of each CPU is small. In particular, the power consumption is reduced by 400 W in a state in which the processing performance of the storage servers SSV has a room.

It is to be noted that, when data of 1 megabyte or the like is read out from or written into the disk apparatus D, as the number of disk apparatus D coupled with one storage server SSV decreases, the degree of parallelism in readout and writing from and into the disk apparatus D drops and the utilization rate UR of the CPU drops. In other words, as the number of disk apparatus D coupled with one storage server SSV increases, the degree of parallelism in readout and writing from and into the disk apparatus D increases and the utilization rate UR of the CPUs increases.

In contrast, when data of 4 kilobytes or the like are read out from and written into the disk apparatus D frequently, the CPU is likely to maintain a high load state without relying upon the number of the coupled disk apparatus D, and the utilization rate UR of the CPU maintains a high state without relying upon the coupling number of disk apparatus D. Also in such a case, by reducing the number of storage servers SSV and increasing the number of disk apparatus D coupled to one storage server SSV, the power consumption is reduced without having an influence on the processing performance.

As described above, also in the embodiment depicted in FIGS. 3 to 30, similar effects to the effects achieved by the embodiment depicted in FIGS. 1 and 2 can be achieved. In particular, the changing unit CHNG changes the number of front end servers FESV or the number of storage servers SSV in response to a variation of the load to the front end servers FESV and the storage servers SSV. Consequently, the bottle neck in the performance of the front end servers FESV and the bottle neck in the performance of the storage servers SSV disappears in response to the variation of the load, and the power consumption is reduced without degrading the processing performance of the information processing system SYS1.

Further, when the number of storage servers SSV is to be increased on the basis of an increase of the load, disk apparatus D are allocated uniformly to the storage servers SSV by a division process of reassigning some of the disk apparatus D to the storage server SSV to be added newly. Further, when the number of storage servers SSV is to be reduced on the basis of a decrease of the load, disk apparatus D are allocated uniformly to the storage servers SSV by a coupling process of reassigning the disk apparatus D coupled with the storage server SSV to be deleted. As a result, the load to the storage servers SSV is distributed and the processing performance of the storage servers SSV is improved.

By suppressing a readout request and a writing request of data from and into a storage server SSV that is executing a division process or a coupling process, such a malfunction that data is not written into a disk apparatus D but is lost is suppressed. As a result, the reliability of the information processing system SYS1 is improved. Further, during execution of a division process or a coupling process, a front end server FESV inputs or outputs data to or from a disk apparatus D coupled with a storage server SSV that is not executing a division process or a coupling process. Consequently, the front end server FESV can execute a readout process or a writing process from or into one of the storage servers SSV even during a division process or a coupling process. As a result, processing of the front end server FESV is suppressed from being stopped by the division process or the coupling process, and degradation of the processing performance of the information processing system SYS1 is suppressed.

After a division process and a coupling process, data is written into a disk apparatus D into which the data has not been written, and thus the data is retained redundantly by a plurality of disk apparatus D. Consequently, the reliability of the information processing system SYS1 that includes storage servers SSV that execute a division process is improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system, comprising:
a load balancer;
a plurality of information processing apparatuses;
a control apparatus including a memory and a processor coupled to the memory, wherein the processor is configured to execute a process including:
selecting, from among the plurality of information processing apparatuses, one or more first information processing apparatuses as each processing node for processing data distributed by the load balancer,
selecting, from among the plurality of information processing apparatuses, one or more second information processing apparatuses as each inputting and outputting node for inputting and outputting data processed by the each processing node,
collecting load information from the one or more first information processing apparatuses and the one or more second information processing apparatuses,
changing a number of the one or more first information processing apparatuses or a number of the one or more second information processing apparatuses based on the load information, data being distributed to the changed one or more first processing apparatuses based on the changing by the load balancer when the number of the one or more first information processing apparatuses is changed, and
setting one or more third information processing apparatuses not selected as the processing node and the inputting and outputting node from among the plurality of information processing apparatuses based on the changing into a deactivated state.

2. The system according to claim 1, wherein
the changing includes selecting one or more fourth information processing apparatuses set in the deactivated state from among the information processing apparatus as the inputting and outputting node when it is determined that a load of at least one of the one or more second information processing apparatuses exceeds a first threshold value based on the load information.

3. The system according to claim 1, further comprising:
a plurality of storage apparatuses,
wherein the process further includes:
coupling a given number of storage apparatus from among the plurality of storage apparatuses to the one or more second information processing apparatuses selected as the inputting and outputting node.

4. The system according to claim 3, wherein
the changing includes selecting one or more fifth information processing apparatuses set in the deactivated state from among the information processing apparatus as the inputting and outputting node when it is determined that a load of at least one of the one or more second information processing apparatuses exceeds a first threshold value based on the load information,
the process further includes:
executing a division process for reassigning at least one of one or more storage apparatuses coupled to the one or more second information processing apparatuses as a target inputting and outputting node of the division process from among the plurality of storage apparatuses to the one or more fifth information processing apparatuses.

5. The system according to claim 4, wherein
the each processing node is configured to:
suspend inputting of data to the target inputting and outputting node of the division process from among the one or more second information processing apparatuses during execution of the division process, and
input the suspended data to the target inputting and outputting node of the division process after the division process is completed.

6. The system according to claim 4, wherein
a plurality of zones to which the given number of storage apparatus are individually allocated are set,
data processed by the processing node are redundantly stored individually into the storage apparatus within a given number of zones from among the plurality of zones, and
the each processing node is configured to:
issue, when a readout request is received from the load balancer, a first request for reading out first target data designated by the readout request from the storage apparatus, in which the first target data is stored, to the inputting and outputting node other than the target inputting and outputting node of the division process from among the inputting and outputting nodes coupled to the storage apparatus individually in the given number of zones.

7. The system according to claim 4, wherein
a plurality of zones to which the given number of storage apparatus are individually allocated are set,
data processed by the processing node are redundantly stored individually into the storage apparatus within a given number of zones from among the plurality of zones, and
the each processing node is configured to:
issue, when a writing request is received from the load balancer, a second request for writing second target data designated by the writing request to the inputting and outputting node other than the target inputting and outputting node of the division process from among the inputting and outputting nodes coupled to the storage apparatus individually in the given number of zones.

8. The system according to claim 7, wherein the each processing node is configured to:
issue, when a transfer request is received from the control apparatus, a third request for transferring the second target data to the inputting and outputting nodes to which the second request is not issued from the storage apparatus in which the second target data is written to the inputting and outputting node coupled to the storage apparatus in which the second target data is written, the inputting and outputting node to which the second request is not issued being is the target inputting and outputting node of the division process from among the inputting and outputting nodes coupled to the storage apparatus individually in the given number of zones.

9. The system according to claim 1, wherein
the changing includes releasing at least one of the one or more second information processing apparatuses from the inputting and outputting node when it is determined that the load of the at least one of the one or more second information processing apparatuses is lower than a second threshold value that is lower than the first threshold value based on the load information, and
the setting sets the released at least one of the one or more second information processing apparatuses into the deactivated state.

10. The system according to claim 9, wherein the process further includes:
executing a coupling process for reassigning the storage apparatus coupled to the released at least one of the one or more second information processing apparatuses as a target inputting and outputting node of the coupling process to at least one of the one or more second information processing apparatus in which the selecting as the inputting and outputting node continues.

11. The system according to claim 10, wherein
the each processing node is configured to:
suspend inputting of data to the target inputting and outputting node of the coupling process from among the one or more second information processing apparatus in which the selecting as the inputting and outputting node continues during execution of the coupling process, and
input the suspended data to the target inputting and outputting node of the coupling process after the coupling process is completed.

12. The system according to claim 10, wherein
a plurality of zones to which the given number of storage apparatus are individually allocated are set,
data processed by the processing node are redundantly stored individually into the storage apparatus within a given number of zones from among the plurality of zones, and
the each processing node is configured to:
issue, when a readout request is received from the load balancer, a fourth request for reading out third target data designated by the readout request from the storage apparatus, in which the third target data is stored, to the inputting and outputting node other than the target inputting and outputting node of the coupling process from among the inputting and outputting nodes coupled to the storage apparatus individually in the given number of zones.

13. The system according to claim 10, wherein
a plurality of zones to which the given number of storage apparatus are individually allocated are set,
data processed by the processing node are redundantly stored individually into the storage apparatus within a given number of zones from among the plurality of zones, and
the each processing node is configured to:
issue, when a writing request is received from the load balancer, a fifth request for writing fourth target data designated by the writing request to the inputting and outputting node other than the target inputting and outputting node of the coupling process from among the inputting and outputting nodes coupled to the storage apparatus individually in the given number of zones.

14. The system according to claim 13, wherein the each processing node is configured to:
issue, when a transfer request is received from the control apparatus, a sixth request for transferring the fourth target data to the inputting and outputting nodes to which the fifth request is not issued from the storage apparatus in which the fourth target data is written to the inputting and outputting node coupled to the storage apparatus in which the fourth target data is written, the inputting and outputting node to which the fifth request is not issued being is the target inputting and outputting node of the coupling process from among the inputting and outputting nodes coupled to the storage apparatus individually in the given number of zones.

15. The system according to claim 1, wherein
the changing includes selecting one or more sixth information processing apparatuses set in the deactivated state from among the information processing apparatus as the inputting and outputting node when it is determined that a load of at least one of the one or more first information processing apparatuses exceeds a third threshold value based on the load information.

16. The system according to claim 15, wherein
the changing includes releasing at least one of the one or more first information processing apparatuses from the processing node when it is determined that the load of the at least one of the one or more first information processing apparatuses is lower than a fourth threshold value that is lower than the third threshold value based on the load information, and
the setting sets the released at least one of the one or more first information processing apparatuses into the deactivated state.

17. The system according to claim 1, wherein
a plurality of zones to which the given number of storage apparatus are individually allocated are set,
data processed by the processing node are redundantly stored individually into the storage apparatus within a given number of zones from among the plurality of zones, and
the each processing node is configured to:
issue, when a readout request is received from the load balancer, a sixth request for reading out fifth target data designated by the readout request from the storage apparatus, in which the fifth target data is stored, to the inputting and outputting nodes coupled to the storage apparatus individually in the given number of zones.

18. The system according to claim 1, wherein
a plurality of zones to which the given number of storage apparatus are individually allocated are set,
data processed by the processing node are redundantly stored individually into the storage apparatus within a given number of zones from among the plurality of zones, and
the each processing node is configured to:
issue, when a writing request is received from the load balancer, a seventh request for writing sixth target data designated by the writing request to the inputting and outputting node coupled to the storage apparatus individually in the given number of zones.

19. A method of controlling a system including a load balancer and a plurality of information processing apparatuses, the method comprising:
selecting, from among the plurality of information processing apparatuses, one or more first information processing apparatuses as each processing node for processing data distributed by the load balancer;
selecting, from among the plurality of information processing apparatuses, one or more second information processing apparatuses as each inputting and outputting node for inputting and outputting data processed by the each processing node;
collecting load information from the one or more first information processing apparatuses and the one or more second information processing apparatuses;
changing a number of the one or more first information processing apparatuses or a number of the one or more second information processing apparatuses based on the load information, data being distributed to the changed one or more first processing apparatuses based on the changing by the load balancer when the number of the one or more first information processing apparatuses is changed; and
setting one or more third information processing apparatuses not selected as the processing node and the inputting and outputting node from among the plurality of information processing apparatuses based on the changing into a deactivated state.

20. An apparatus configured to control a system including a load balancer and a plurality of information processing apparatuses, the apparatus comprising:
a memory; and
a processor coupled to the memory and configured to execute a process including:
selecting, from among the plurality of information processing apparatuses, one or more first information processing apparatuses as each processing node for processing data distributed by the load balancer,
selecting, from among the plurality of information processing apparatuses, one or more second information processing apparatuses as each inputting and outputting node for inputting and outputting data processed by the each processing node,
collecting load information from the one or more first information processing apparatuses and the one or more second information processing apparatuses,
changing a number of the one or more first information processing apparatuses or a number of the one or more second information processing apparatuses based on the load information, data being distributed to the changed one or more first processing apparatuses based on the changing by the load balancer when the number of the one or more first information processing apparatuses is changed, and
setting one or more third information processing apparatuses not selected as the processing node and the inputting and outputting node from among the plurality of information processing apparatuses based on the changing into a deactivated state.
